(19) United States
(12) Patent Application Publication
(10) Pub. No.: US 2015/0227703 A1
(43) Pub. Date: Aug. 13, 2015

(54) Display Apparatus and Image Display System

(71) Applicant: GE Medical Systems Global Technology Company LLC, Waukesha, WI (US)

(72) Inventors: Tatsuo Kawanaka, Tokyo (JP); Takuya Shimomura, Tokyo (JP); Takeyoshi Uenishi, Tokyo (JP)

(21) Appl. No.: 14/416,483

(22) PCT Filed: Jul. 24, 2013
(86) PCT No.: PCT/US2013/051859

§ 371 Date: Jan. 22, 2015

(30) Foreign Application Priority Data
Jul. 26, 2012 (JP) 2012-165819

(51) Int. Cl. G06F 19/00; G06F 3/0484; G06F 3/0482

(52) U.S. Cl. CPC G06F 19/3406; G06F 3/0482; G06F 3/04842; G06F 3/04845

(57) ABSTRACT

A display apparatus including: a display controller for displaying a view of simplified images based on medical data having accompanying information of a plurality of attributes as metadata, wherein said view of simplified images being a matrix-like view in which the simplified images of the same patient are arranged by accompanying information of one attribute in a row direction and arranged by accompanying information of another attribute in a column direction; and an input unit in which an operator performs input of changing the attribute in at least one of the row and column directions. The display controller rearranges the simplified images by accompanying information of the attribute that the operator changed using the input unit.

### BACKGROUND OF THE INVENTION

The present invention relates to a display apparatus and an image display system which display a view of simplified images of a patient.

A display apparatus, which is connected to a server via Network and displays images based on medical data stored in the server, has been described in, for example, Japanese Unexamined Patent Publication No. 2010-182018.

The medical data stored in the server are data of medical images such as X-ray CT images captured by an X-ray CT (Computed Tomography) apparatus, MRI images captured by an MRI (Magnetic Resonance Imaging) system, etc. for example.

In addition to the above, the medical data include those or the like in which documents of paper used in hospitals, such as a patient referral document, etc. are scanned and brought into data form.

### SUMMARY OF THE INVENTION

Meanwhile, there is a case where quite a number of medical images and documents have been created and stored with respect to patients that visit a hospital. It is thus required that necessary data are to be capable of being easily found out of lots of their data.

The invention of one aspect made to solve the above problems provides a display apparatus including a display controller for displaying a view of simplified images based on medical data having accompanying information of a plurality of attributes as metadata, wherein said view of simplified images being a matrix-like view in which the simplified images of the same patient are arranged by accompanying information of one attribute in a mw direction and arranged by accompanying information of another attribute in a column direction; and an input unit in which an operator performs input of changing the attribute in at least one of the row and column directions, wherein the display controller rearranges the simplified images by accompanying information of the attribute that the operator changed using the input unit.

The invention of another aspect provides the display apparatus in which in the invention of the one aspect, wherein the input unit is capable of performing the input of selecting the accompanying information by the operator, and wherein the display controller causes the view to be displayed includes only simplified images having the accompanying information selected by the operator using the input unit.

The invention of a further aspect provides the display apparatus in which in the invention of the above aspect, wherein the display controller causes the view to be displayed includes only simplified images having accompanying information of different attributes selected before and after the attribute change by the operator using the input unit.

The invention of yet another aspect provides a display apparatus including a display controller for displaying a view of simplified images based on medical data having accompanying information of a plurality of attributes as metadata, wherein said view of simplified images is a matrix-like view in which the simplified images of the same patient are arranged by accompanying information of one attribute in a row direction and arranged by accompanying information of another attribute in a column direction; and an input unit which performs the input of changing the attribute in at least one of the column and row directions by selecting a desired attribute by an operator out of the plurality of attributes displayed in the display unit and the input of selecting desired accompanying information from the view displayed in the display unit; wherein the display controller rearranges the simplified images by accompanying information of the attribute changed by the input unit and causes a view to be displayed includes only simplified images having the accompanying information selected by the input unit.

The invention of a still further aspect provides the display apparatus in which in the invention of the one aspect, wherein the input unit is capable of performing the input of selecting accompanying information of the attribute changed using the input unit by the operator, and wherein the display controller causes the view to be displayed includes only simplified images having the accompanying information selected using the input unit by the operator.

The invention of a still further aspect provides the display apparatus in which in the invention of the above aspect, wherein, the input unit is capable of performing the input of changing the attribute of the accompanying information selected using the input unit by the operator, and wherein when the input of changing the attribute of the accompanying information selected using the input unit by the operator is performed, the display controller rearranges the simplified images by accompanying information of the post-change attribute.

According to the invention of the above aspect, since the attributes can be changed, a view can be displayed in such a manner that necessary simplified images can easily be found out.

According to the invention of another aspect described above, when the operator performs the input of selecting the accompanying information at the input unit, a view includes only simplified images having the selected accompanying information is displayed. It is thus possible to display a view in which only simplified images necessary for the operator have been extracted.

According to the invention of yet another aspect described above, a view includes only simplified images having accompanying information of different attributes selected before and after the attribute change by the operator using the input unit is displayed, thereby making it possible to display simplified images necessary for the operator.

According to the invention of the further aspect described above, the alternation of each attribute and the selection of accompanying information are performed at the display unit, thereby making it possible to display a view in which only simplified images necessary for the operator have been extracted by a simple operation on the screen.

According to the invention of the still further aspect described above, when the operator performs the input of changing each attribute using the input unit and selecting accompanying information of the changed attribute, a view includes only simplified images having the selected accompanying information is displayed. It is thus possible to extract only simplified images necessary for the operator easier.

According to the invention of the still further aspect described above, when the operator performs the input of selecting accompanying information using the input unit and changing the attribute of the selected accompanying information, simplified images rearranged for every accompanying information of the post-change attribute are displayed. It is thus possible to extract only simplified images necessary for the operator easier.

### BRIEF DESCRIPTION OF THE DRAWINGS

A more complete appreciation of the disclosed embodiments of the invention and many of the attendant advantages thereof will be readily obtained as the same becomes better understood by reference to the following detailed description when considered in connection with the accompanying drawings, wherein:

FIG. 1 is a block diagram of an image display system according to an embodiment;

FIG. 2 is a diagram showing a display unit on which a view is displayed;

FIG. 3 is a flowchart showing the operation of the image display system in a first embodiment;

FIG. 4 is a diagram illustrating a display unit being in a state in which a cursor is moved onto an attribute selection image;

FIG. 5 is a diagram depicting the display unit on which an attribute selection image is displayed;

FIG. 6 is a diagram showing the display unit being in a state in which the cursor is placed on a desired attribute at the attribute selection image;

FIG. 7 is a diagram illustrating the display unit on which a view subsequent to the alternation of an attribute is displayed;

FIG. 8 is a diagram depicting the display unit being in a state in which desired accompanying information is selected from the view;

FIG. 9 is a diagram showing the display unit being in a state in which the cursor is placed on a narrow-down display button;

FIG. 10 is a diagram illustrating the display unit on which only simplified images having selected accompanying information are displayed;

FIG. 11 is a diagram depicting the display unit where the input of changing an attribute is performed again.

FIG. 12 is a diagram showing the display unit on which a view after each attribute has been changed again is displayed;

FIG. 13 is a diagram showing the display unit being in a state in which desired accompanying information is selected again from the view;

FIG. 14 is a diagram illustrating the display unit on which only simplified images having selected accompanying information are displayed;

FIG. 15 is a diagram depicting the display unit being in a state in which the cursor is placed on a metadata display button;

FIG. 16 is a diagram showing the display unit on which a metadata display image is displayed;

FIG. 17 is a diagram illustrating the display unit being in a state in which the cursor is placed on a Save button in the metadata display image;

FIG. 18 is a diagram depicting the display unit on which a name registration image for registering the name of a narrow-down condition is displayed;

FIG. 19 is a diagram showing the display unit being in a state in which the name registered in the metadata display image is displayed;

FIG. 20 is a diagram illustrating the display unit being in a state in which the name is displayed on a search button by a drag-and-drop operation;

FIG. 21 is a flowchart showing the operation of an image display system in a second embodiment;

FIG. 22 is a diagram depicting a display unit being in a state in which a cursor is moved onto an attribute selection icon;

FIG. 23 is a diagram showing the display unit being in a state in which the cursor is placed on a desired attribute at an attribute selection image;

FIG. 24 is a diagram illustrating the display unit on which a view after each attribute has been changed is displayed;

FIG. 25 is a diagram showing the display unit being in a state in which desired accompanying information is selected from a view;

FIG. 26 is a diagram depicting the display unit on which only simplified images having selected accompanying information are displayed;

FIG. 27 is a diagram showing the display unit where the input of changing an attribute is performed again;

FIG. 28 is a diagram illustrating the display unit on which a view after each attribute has been changed again is displayed;

FIG. 29 is a diagram depicting the display unit on which a first attribute selection image and a second attribute selection image for changing the attributes of display sections of two accompanying information are displayed; and

FIG. 30 is a diagram showing the display unit on which a metadata display image is displayed where the attributes of display sections for two accompanying information can be changed.

### DETAILED DESCRIPTION OF THE INVENTION

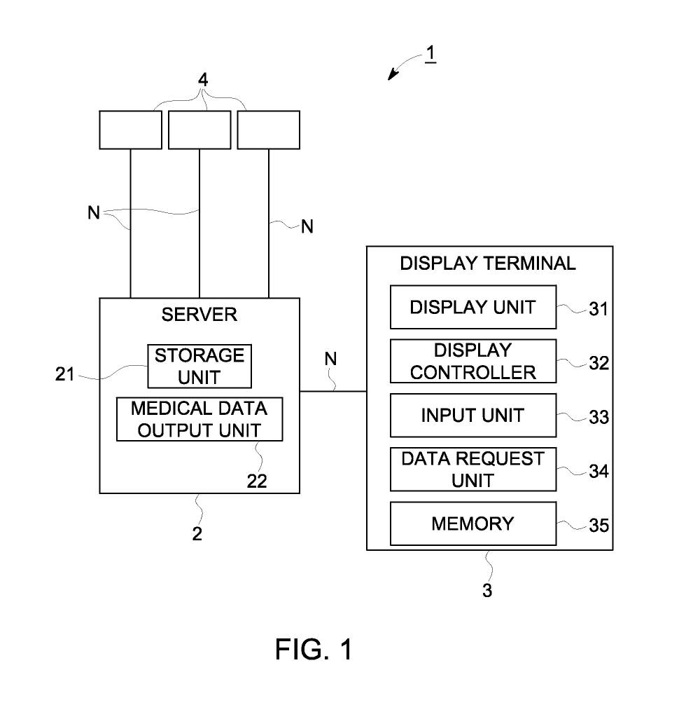

Embodiments of the present invention will hereinafter be described. A first embodiment will first be described based on FIGS. 1 through 20. An image display system 1 shown in FIG. 1 is equipped with a server 2 and a display terminal 3 connected via network N. A plurality of department systems 4 are connected to the server 2 via network N. The image display system 1 is one example illustrative of an embodiment of an image display system according to the present invention. The display terminal 3 is one example illustrative of an embodiment of a display apparatus according to the present invention.

The server 2 has a storage unit 21 and a medical data output unit 22. The storage unit 21 is, for example, an HDD (Hard Disk Drive) or the like. Medical data or the like inputted from each department system 4 to the server 2 via the network N have been stored in the storage unit 21. The server 2 is one example illustrative of an embodiment of a server in the present invention. The storage unit 21 is one example illustrative of a storage unit in the present invention.

The medical data stored in the storage unit 21 are data related to patients, which are generated in a medical provision facility, an inspection facility for performing the inspection of a specimen, etc. The data include medical image data, document data, numeric data, etc. The medical image data are data acquired by the modality or the like of the department system 4, e.g., image data such as an X-ray CT image, an MRI image, an ultrasound image, etc. The document data are data about, for example, a radiographic interpretation report, a patient referral document, informed consent forms such as a surgery consent form, an inspection consent form, a medical questionnaire, an application blank, a result of inspection, etc. The document data include PDF (Portable Document Format) data set in the form of data by scanning each paper document, etc. The numeric data are data of numeric values related to patients, for example, numeric data indicative of inspection results such as a blood test, etc.

The medical data also include data or the like about a progress note of patient's biological information such as an electrocardiogram, etc., other records related to patients in addition to the medical image data and the document data listed above.

The medical data include metadata in addition to the body of data. The metadata includes accompanying information of a plurality of attributes such as the name of a patient, a date, a document class, a type code, a practice setting, etc. Here, the term of “accompanying information” means a specific name, a date, a document class, a type code and a practice setting. The attributes means the attributes associated with these accompanying information. For example, the accompanying information about the attribute of “document class” is “CT”, “MRI” or the like. The accompanying information about the attribute of “practice setting” is “radiology department”, “cardiovascular department” or the like. The metadata is a concept that includes information (e.g., information referred to as “document class”) about an attribute, and specific information (i.e., accompanying information, e.g., information referred to as “CT”) about the attribute.

The metadata includes one automatically applied to each of the department systems 4, and one applied by performing an input from an operator, such as a modality of an X-ray CT apparatus or the like, etc.

The date for the metadata corresponds to the creation date of medical data, for example. The date for the metadata may include the year, the time and so on as well as the day. If medical image data is used, then the date of image shooting or capturing may be set as a creation date. If document data is used, then the created date of a document may be a creation date. Alternatively, the date when a document was scanned and brought into data form may be a creation date.

The document class for the metadata is of information indicative of the type of medical data, e.g., information indicative of the type of medical images of MRI (Magnetic Resonance Imaging), US (Ultrasound) and the like, and the type of documents such as a hospitalization consent form, an application blank for hospitalization, a medical questionnaire for hospitalization, an inspection consent form, a surgery consent form, etc. The type code for the metadata is information indicative of a superordinate concept of a document class, for example, a consent form or the like.

The practice setting for the metadata is information indicative of a department to which a request to generate medical data is made, such as the radiology department, the cardiovascular department or the like.

The attributes for the metadata may be determined in advance. Even when they are determined in advance, the attributes may be supposed to be able to perform their addition and deletion.

The medical data output unit 22 outputs the medical data stored in the storage unit 21 to the display terminal 3 according to a request from the display terminal 3.

The display terminal 3 is a general-purpose personal computer. The display terminal 3 has a display unit 31, a display controller 32, an input unit 33, a data request unit 34 and a memory 35.

The display unit 31 is an LCD (Liquid Crystal Display), a CRT (Cathode Ray Tube) or the like.

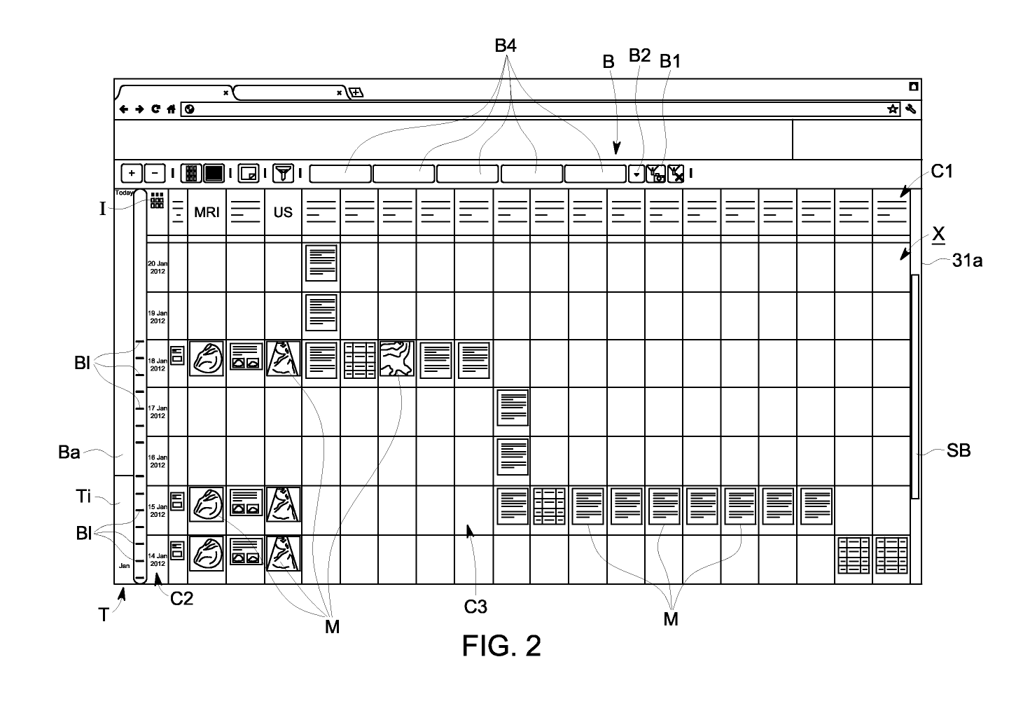

As shown in FIG. 2, the display controller 32 causes a display screen 31a of the display unit 31 to display a view X of simplified images M of the same patient based on the medical data stored in the storage unit 21. The display controller 32 is one example illustrative of an embodiment of a display controller in the present invention.

The view X includes display sections C1 and C2 for accompanying information and a display section C3 for each simplified image. These display sections C1 and C2 and C3 are made up of cells. The display section C1 for the accompanying information includes cells that configure the top mw arranged in a row direction (lateral direction) in the view X. The display section C2 for the accompanying information includes cells that configure the leftmost column arranged in a column direction (lengthwise direction) in the view X.

The display controller 32 causes the display section C1 for the accompanying information to display accompanying information of the same attribute. The display controller 32 causes even the display section C2 for the accompanying information to display accompanying information of the same attribute. Accompanying information of different attributes is displayed in the display sections C1 and C2. In FIG. 2, a document class is displayed in the display section C1 for the accompanying information, and the date (year, month and day) is displayed in the display section C2 for the accompanying information. The accompanying information displayed in the display section C1 for the accompanying information is one example illustrative of an embodiment of accompanying information of one attribute in the present invention. Also the accompanying information displayed in the display section C2 for the accompanying information is one example illustrative of an embodiment of accompanying information of other attributes in the present invention.

It is possible to change the attributes of the display sections C1 and C2 for the accompanying information. An attribute change icon (icon) I is displayed on the left side of the display section C1 and the upper side of the display section C2. An operator clicks the attribute change icon I to thereby make it possible to change the attributes of the display sections C1 and C2. The details thereof will be described later.

Simplified images M based on medical data are displayed in the display section C3. The simplified image M is a thumbnail image or the like. A description will be made of the generation of the simplified images M. When each simplified image M displayed in the display section C3 is of a medical image based on the medical image data, a sheet of medical image data (data acquired from the server 2) selected out of a plurality of sheets of medical image data generated at one inspection is selected. Of the plurality of sheets of medical image data generated at one inspection, the first data or intermediate data may automatically be selected. Then, the selected one sheet of medical data is converted to a suitable size to display it in the view X. This size is a size of such an extent that it can be arranged on the display screen 31a in a state in which a view property has been maintained (e.g., 64×64 pixels, 96×96 pixels, etc.). The simplified images M based on the so-converted medical image data are displayed in the display section C3. When the simplified images M are images based on document data, e.g., data about a sheet of document is selected if the document data is data about a plurality of sheets of documents. The selected data is converted to a suitable size as with the above. Then, each simplified image M based on the converted data is displayed in the display section C3.

When the medical data displayed as the simplified image M is numeric data, an image indicative of the contents of the numeric data is generated and displayed as a simplified image M. For example, the image indicative of the contents of the numeric data is an image including characters indicative of the contents of the numeric data. As to numeric data about a blood test, to take one example, an image including characters of “blood test” is displayed as the simplified image M.

By causing the operator to click each simplified image M displayed in the display section C3 using the input unit 33, the display controller 32 may allow the enlarged simplified image M to be displayed.

Accompanying information in the lengthwise direction (column direction) of the display section C3 are displayed in the display section C1. Accompanying information in the lateral direction (row direction) of the display section C3 are displayed in the display section C2. Simplified images M are arranged in matrix form in the display section C3. Simplified images M having the accompanying information displayed in the display section C1 are arranged in the display section C3 as viewed in the column direction. Simplified images M having the accompanying information displayed in the display section C2 are arranged in the same display section as viewed in the mw direction. In the view X, the corresponding simplified image M is placed in a position specified from the two accompanying information of the display sections C1 and C2.

Specifically, in FIG. 2, there is shown a view X in which simplified images M of respective document classes are arranged in the column direction, and simplified images M of respective dates are arranged in the mw direction. Described to take an example, the display controller 32 causes a simplified image M (MRI image) based on medical data having information (MRI) indicative of an MRI image as accompanying information to be displayed in a column in which “MRI” of the display section C1 for the accompanying information is displayed, in the display section C3. Also the display controller 32 causes a simplified image M based on medical data having date information of 2012 Jan 12, as accompanying information to be displayed in a mw displayed as “18 Jan 2012” of the display section C2 for the accompanying information, for example, in the display section C3. Thus, the display controller 32 causes the view X in which the simplified images M are arranged in the row direction for every accompanying information of one attribute and arranged in the column direction for every accompanying information of other attributes, to be displayed.

When the attributes of the display sections C1 and C2 for the accompanying information are changed, the display controller 32 rearranges the simplified images M in accordance with their alterations. The details thereof will be described later.

The view X can be scrolled by scrolling a longitudinal scroll bar SB and a transverse scroll bar (not shown).

The display controller 32 causes the display unit 31 to display a period image T and various buttons B in addition to the view X. The period image T has a bar Ba and an acquisition time indication block Bl. The bar Ba indicates a period from the oldest date of the dates of the accompanying information about the medical data stored in the storage unit 21 of the server 2 to the present (present in which the view Xis being displayed) with respect to a patient with a view X displayed in the display unit 31.

A period indication image Ti is displayed on the bar Ba. The period indication image Ti is displayed in a color different from another part at the bar Ba. The period indication image Ti shows a period from the oldest date of the dates of the accompanying information about the simplified images M displayed in the display unit 31 to the latest date. When the view Xis scrolled in the vertical direction, the period indication image Ti moves on the bar B with its scrolling.

The acquisition time indication block B1 shows the date of the accompanying information about the medical data during a period indicated by the period image T. Owing to the acquisition time indication block B1, it is possible to know when the medical data has been generated.

The input unit 33 is made up of a keyboard, a mouse or the like. The input unit 33 is one example illustrative of an embodiment of an input unit in the present invention. The data request unit 34 outputs a signal for requesting medical data to the server 2, based on an operator's input in the input unit 33.

The department system 4 is a department system in a hospital, such as an RIS (Radiology Information System) including modalities of an X-ray CT apparatus, an MRI system and the like.

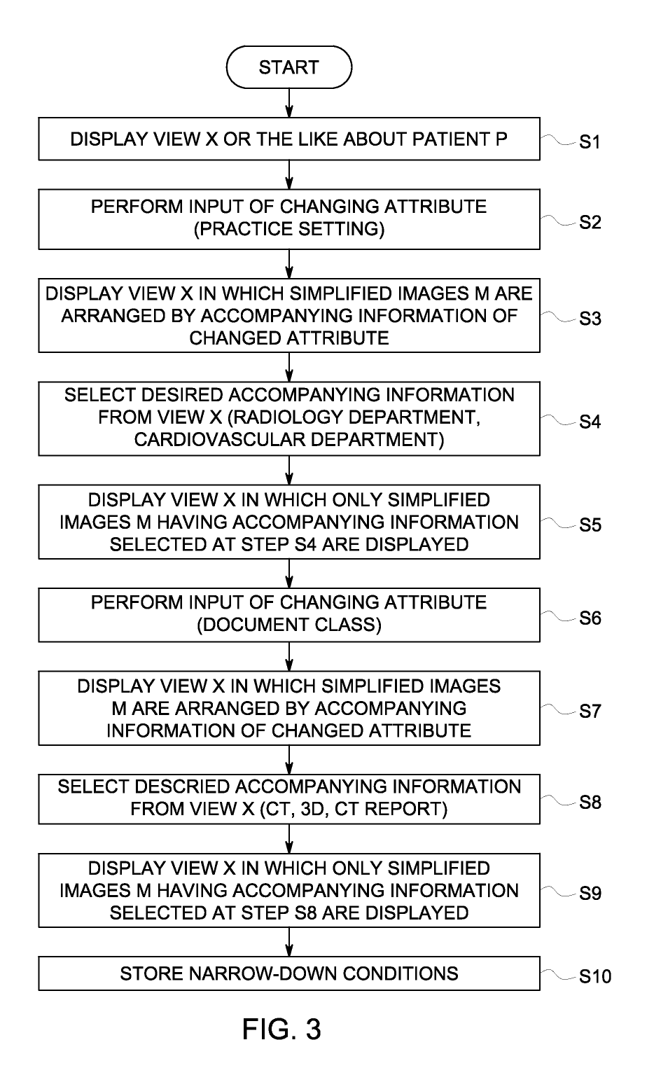

The operation of the image display system 1 of the present embodiment will next be described based on a flowchart of FIG. 3. First, at Step S1, the display controller 32 allows the display unit 31 to display a view X about a given patient P (refer to FIG. 2). Specifically, the operator inputs specific information of the patient P, such as his/her name and ID, etc. through the input unit 33 of the display terminal 3. Next, the data request unit 34 requests of the server 2, medical data related to the patient P whose specific information being input by the operator. The medical data output unit 22 of the server 2 outputs all medical data of the patient P stored in the storage unit 21 to the display terminal 3, based on the request from the data request unit 34. The medical data are assumed to have been generated in plural form when different in terms of the patient P.

The display controller 32 causes the display unit 31 to display the view X based on the medical data inputted from the server 2. Also the display controller 32 causes the display unit 31 to display the period image T, the buttons B and the like in addition to the view X. The display controller 32 causes the period image T to be displayed using the date information in the accompanying information.

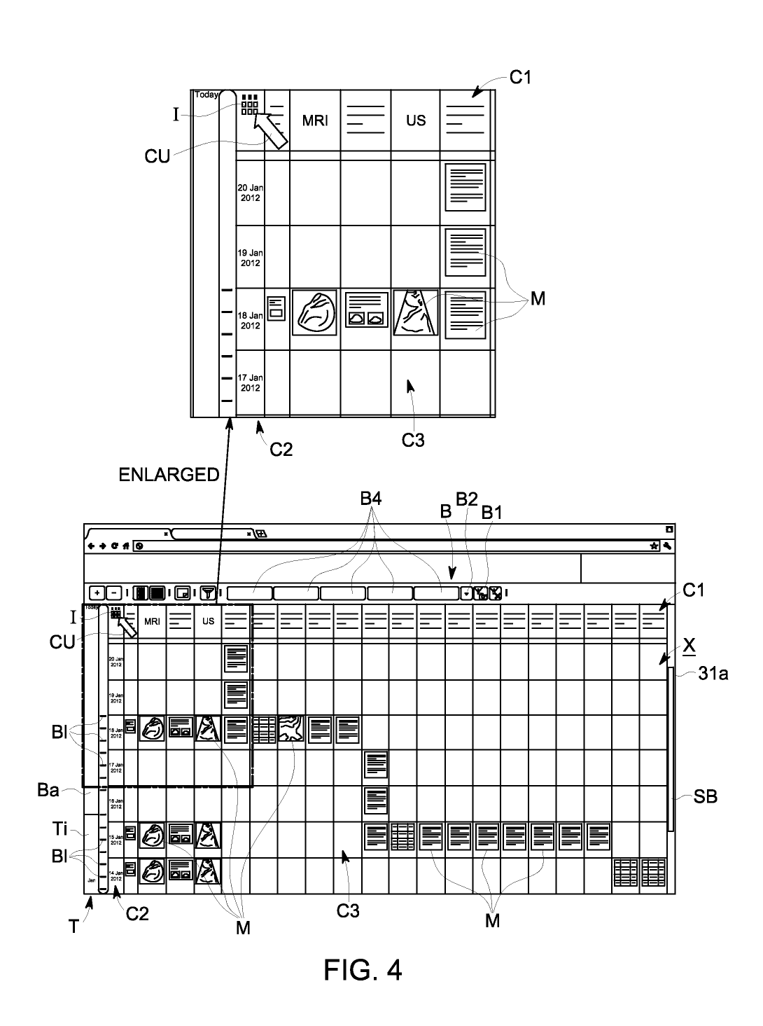

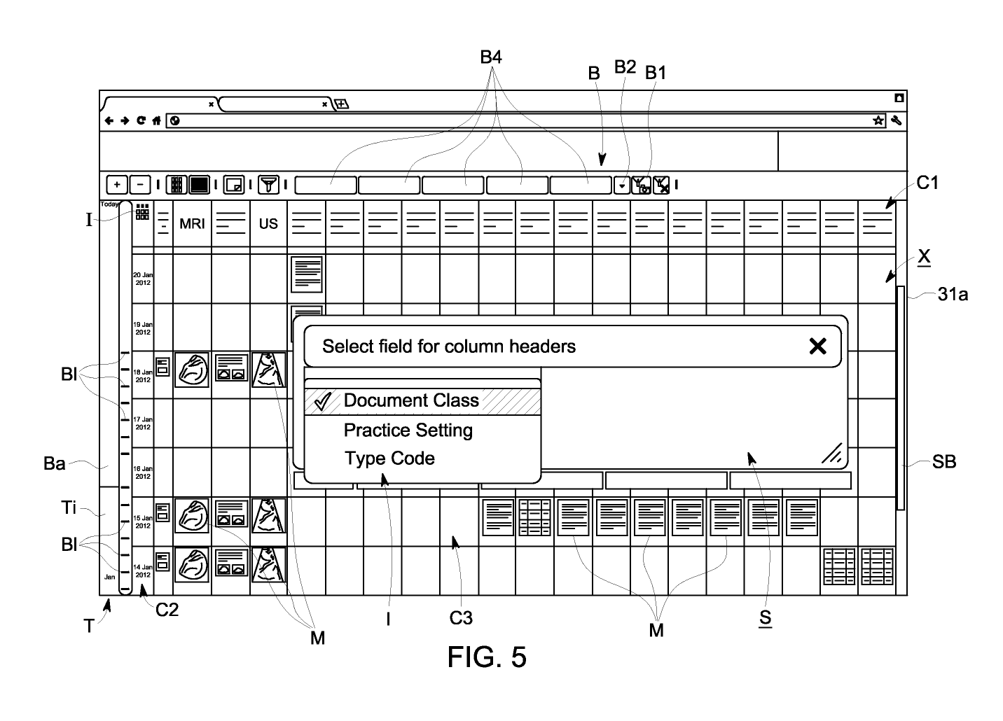

Next, at Step S2, the operator performs the input of changing each attribute of the display section C1 for the accompanying information through the input unit 33. Concretely, the operator first moves a cursor CU onto the attribute change icon I using the input unit 33 as shown in FIG. 4. When the attribute change icon I is clicked, the display controller 32 causes an attribute selection image S to be displayed as shown in FIG. 5.

The attribute selection image S includes a list 1 of attributes of accompanying information. In FIG. 5, “Document Class”, “Practice Setting”, and “Type Code” are displayed as the attributes in the list 1. In FIG. 5, the “Document Class” corresponding to the attribute displayed at the present in the display section C1 is highlighted in the list 1.

Incidentally, the attributes of the accompanying information displayed in the attribute selection image S are not limited to the above three. Other attributes may be displayed in the attribute selection image S. The operator may become able to edit (add or delete) each attribute displayed in the attribute selection image S through the use of the input unit 33.

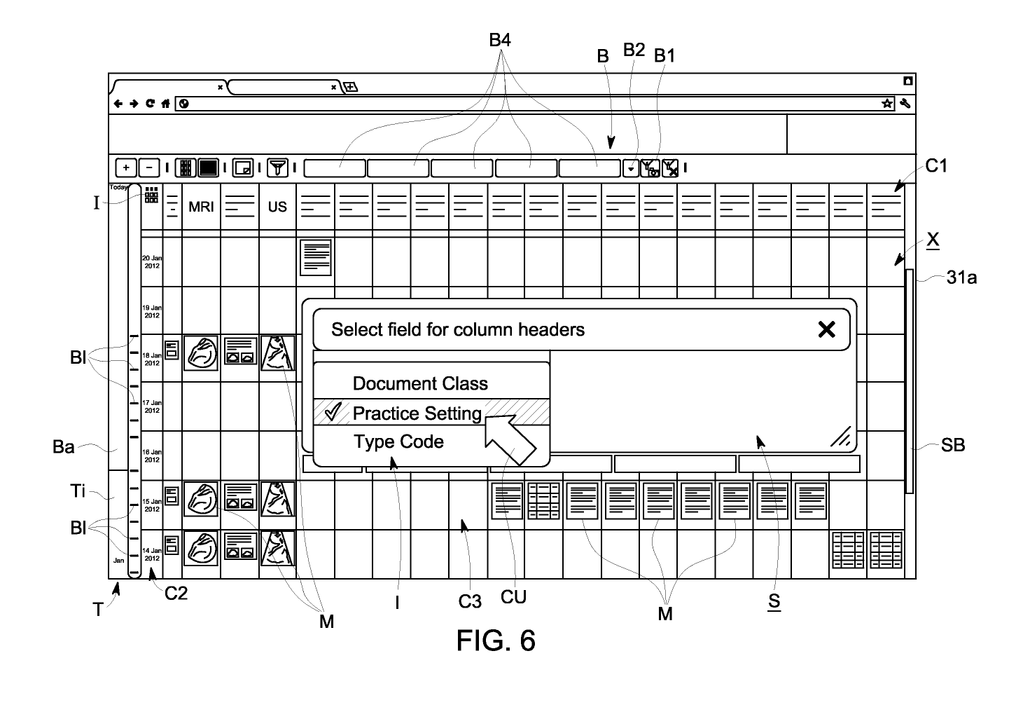

Next, the operator puts the cursor CU on a desired attribute in the list 1 to click it as shown in FIG. 6. Assume here that the operator desires to display each simplified image M for every practice setting in the view X. Thus, the cursor CU is placed on the “Practice Setting” in FIG. 6.

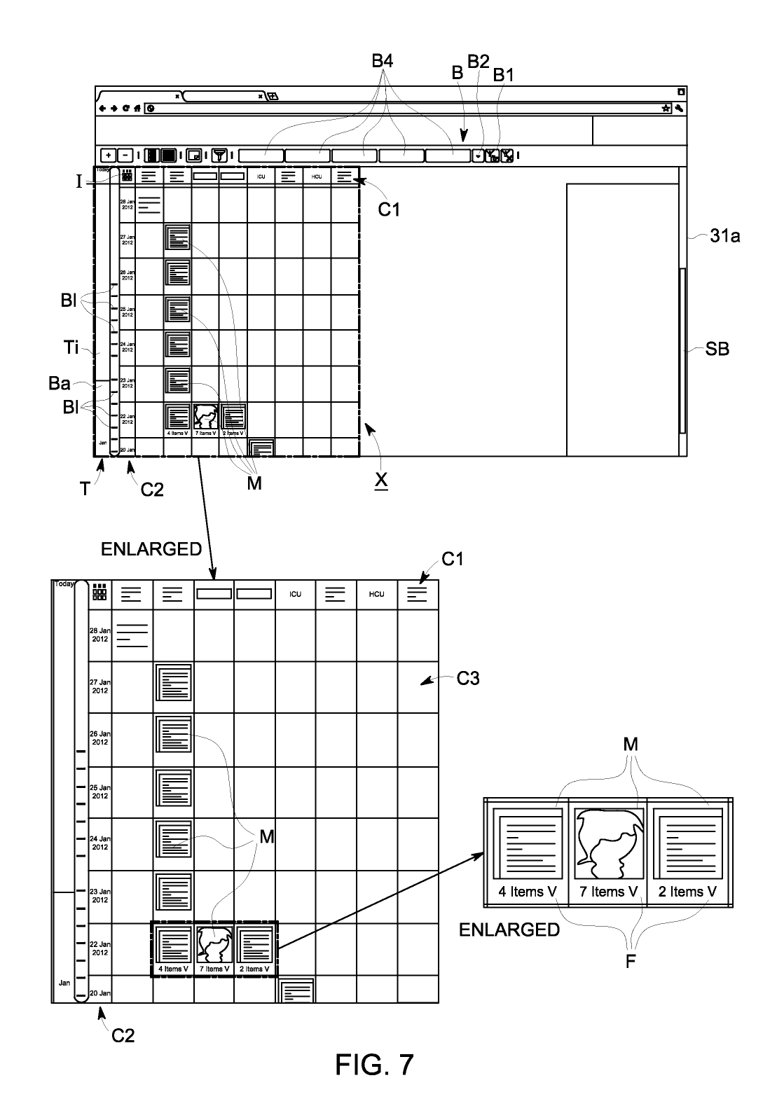

At Step S2, when the cursor CU is placed and clicked in the list 1 as an input for changing the attribute, the display controller 32 causes a view X with the simplified images M rearranged for every accompanying information of the selected attribute to be displayed as shown in FIG. 7 at Step S3. Since “Practice Setting” is selected at Step S2 here, the practice setting is displayed in the display section C1 and yet a view Xis displayed in which simplified images M for respective practice settings are arranged in the lengthwise direction (column direction).

Since the attributes can be changed in this manner, the view X can be displayed in such a manner that the operator is able to easily find out and select the simplified image necessary for the operator.

Here, when simplified images M specified from the two accompanying information corresponding to the accompanying information displayed in the display section C1 and the accompanying information displayed in the display section C2 exist in plural form, the simplified images M to be displayed in one cell in the display section C3 exist in plural form. In this case, the display controller 32 causes only any one M of the simplified images M to be displayed in one cell and causes a numerical representation F indicative of how many simplified images exit to be displayed. The numerical representation F is one example illustrative of an embodiment of a numerical representation in the present invention.

Specifically, in FIG. 7, only one simplified image M is displayed in the corresponding display section C3 of simplified image in which the accompanying information displayed in the display section C1 corresponds to “3 hospital ward” and yet the accompanying information displayed in the display section C2 corresponds to “22 Jan 2012”. Characters of “4items” are displayed as the numerical representation F. This means that there are four simplified images M in each of which the practice setting is “3 hospital ward” and the date is “2012 Jan 22”. Only one simplified image M is displayed in the corresponding display section C3 of simplified image in which the accompanying information displayed in the display section C1 is “radiology department” and yet the accompanying information displayed in the display section C2 corresponds to “22 Jan 2012”. Characters of “litems” are displayed as numeral F. This means that there are seven simplified images M in each of which the practice setting is “radiology department” and the date is “2012 Jan 22”. Further, only one simplified image M is displayed in the corresponding display section C3 of simplified image in which the accompanying information displayed in the display section C1 is “cardiovascular department” and yet the accompanying information displayed in the display section C2 corresponds to “22 Jan 2012”. Characters of “2items” are displayed as the numerical representation F. This means that there are two simplified images M in each of which the practice setting is “cardiovascular department” and the date is “2012 Jan 22”.

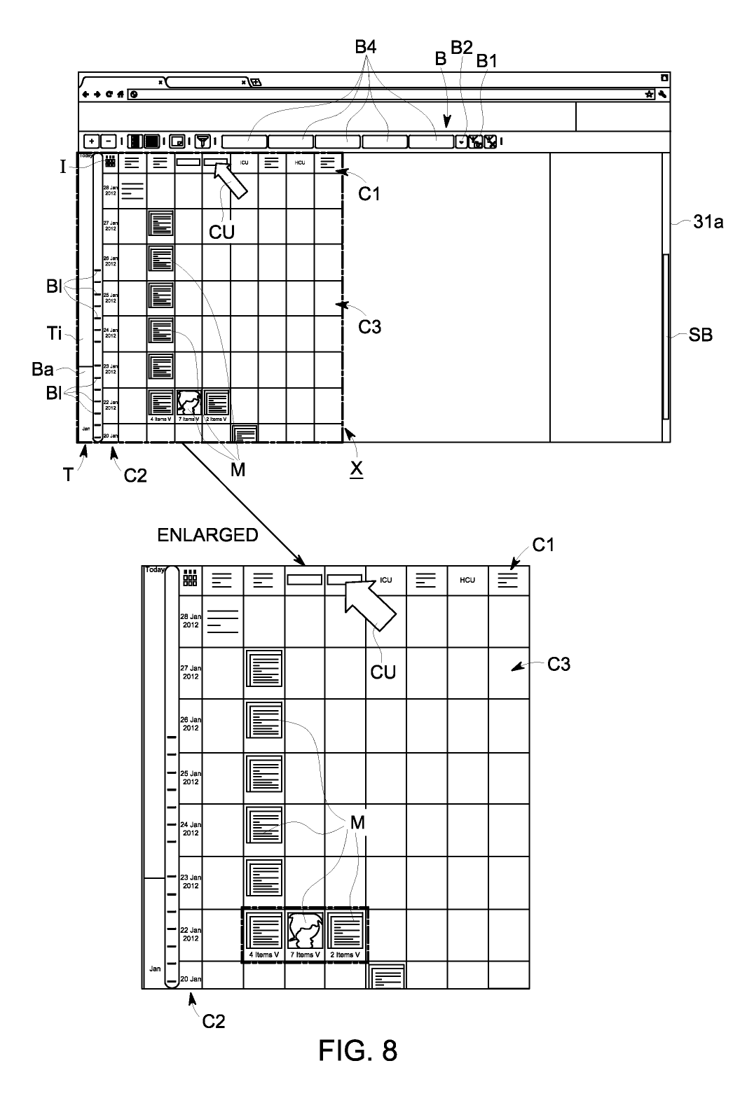

Next, at Step S4, the operator selects desired accompanying information from the view X. Specifically, as shown in FIG. 8, the operator moves the cursor CU onto the desired accompanying information of the accompanying information displayed in the display section C1 to click the same information. The clicked accompanying information is highlighted. Here, the “radiology department” and the “cardiovascular department” have been selected.

The cursor CU is however moved to the display section C3 other than the display section C1 to click, whereby accompanying information in a clicked column may be selected.

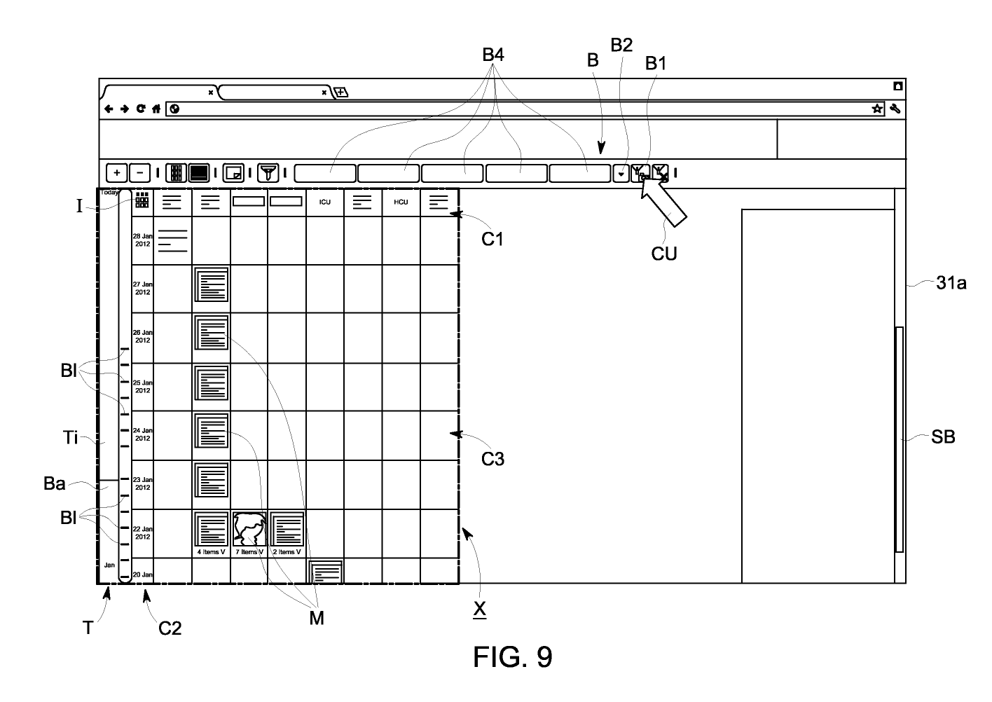

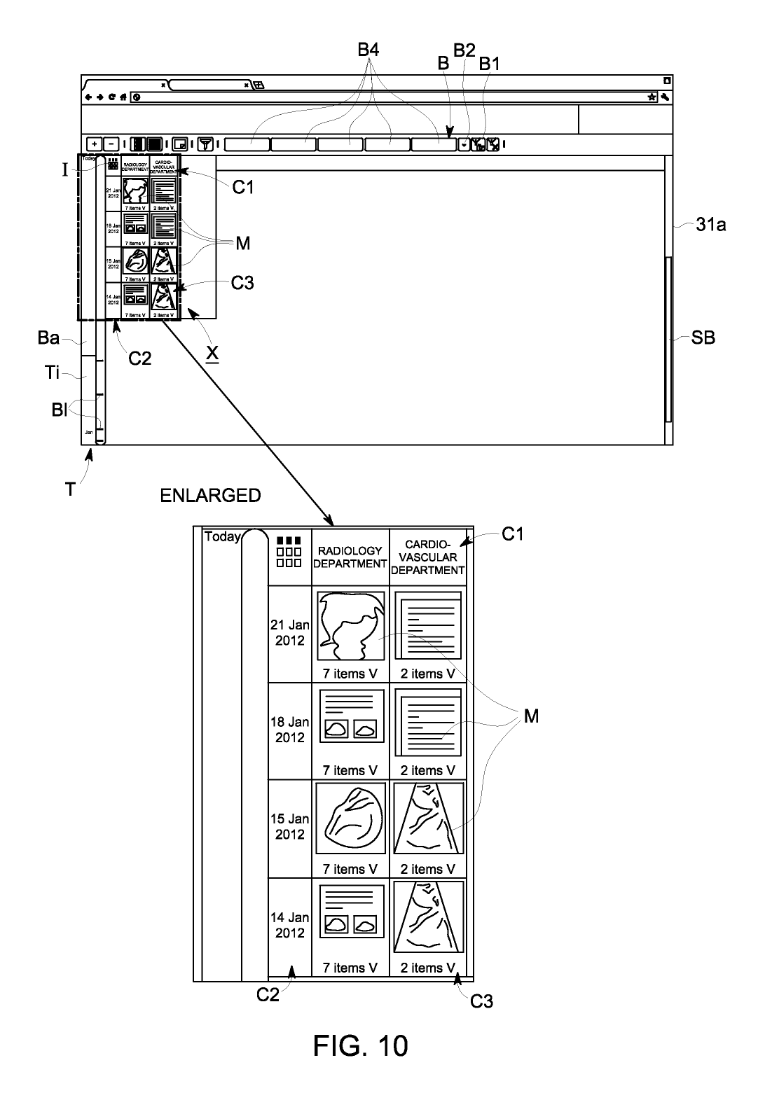

Next, at Step S5, the operator causes a view X in which only simplified images M having the accompanying information selected at Step S4 has been displayed, to be displayed. Specifically, as shown in FIG. 9, in a state in which the “radiology department” and the “cardiovascular department” have been selected, the operator puts the cursor CU on a narrow-down display button B1 of the display unit 31 using the input unit 33 to click the narrow-down display button B1. When the narrow-down display button B1 is clicked, the display controller 32 causes a view X with only simplified images M of “radiology department” and “cardiovascular department” being displayed therein to be displayed as shown in FIG. 10.

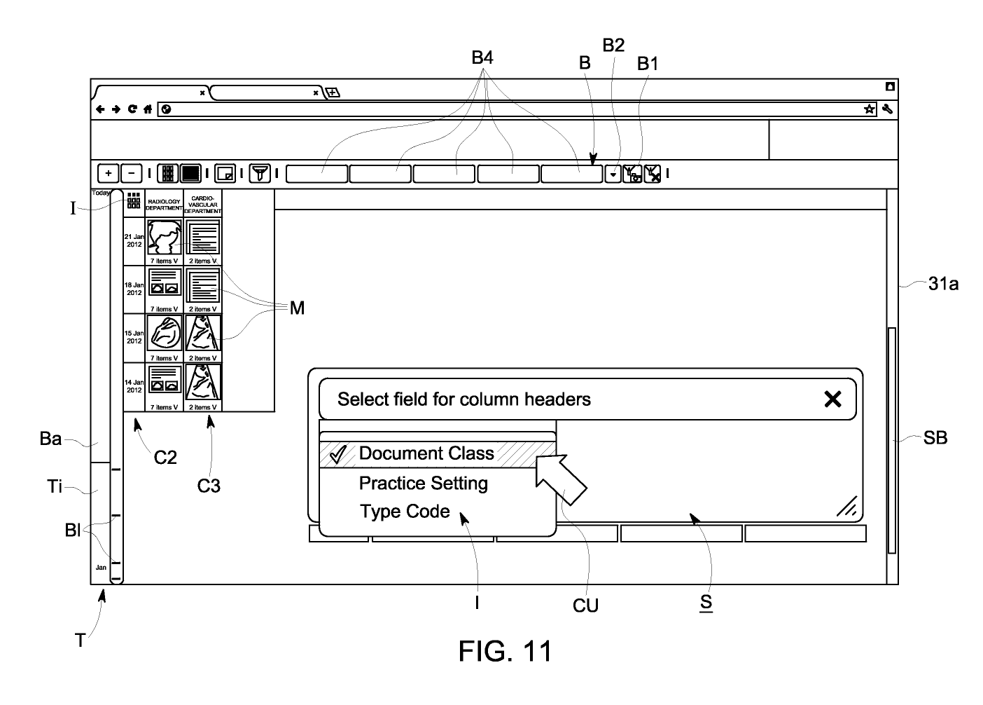

Next, at Step S6, the operator performs an operation similar to Step S2 to conduct again the input of changing the attribute of the display section C1. Here, as shown in FIG. 11, “Document Class” is selected at an attribute selection image S.

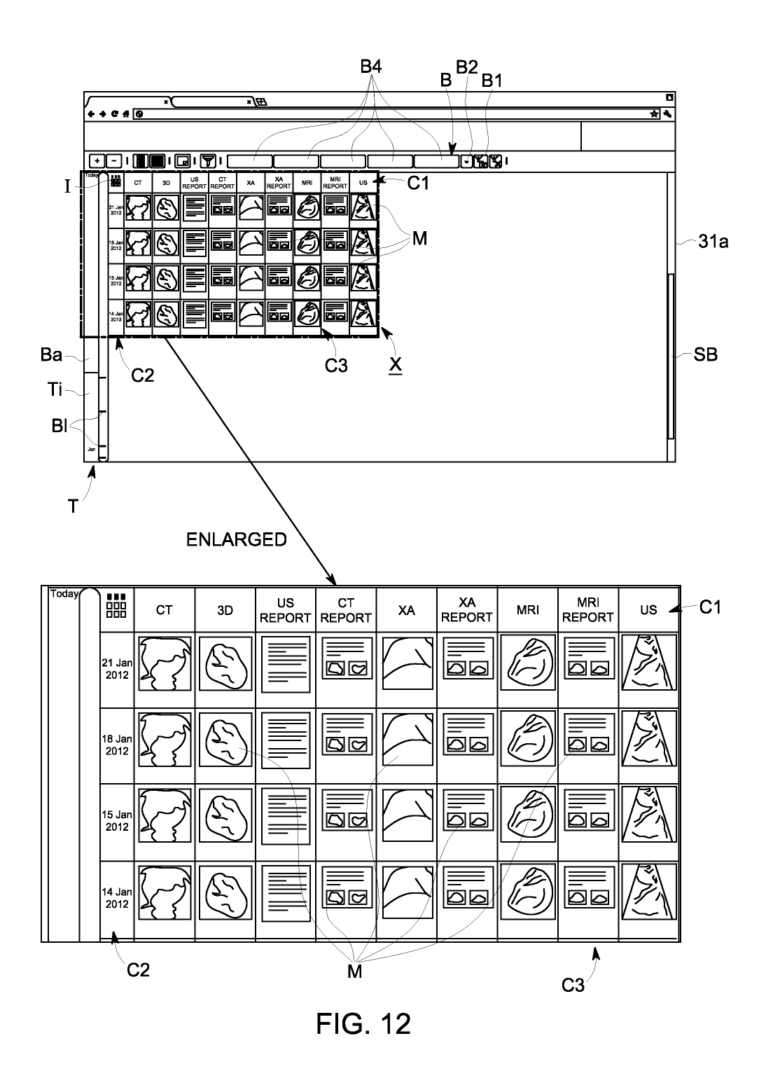

When the “Document Class” is selected at Step S6, at Step S7 as shown in FIG. 12, the display controller 32 causes document classes to be displayed in the display section C1 and yet causes a view X in which simplified images M of the respective document classes are arranged in the column direction in the display section C3, to be displayed.

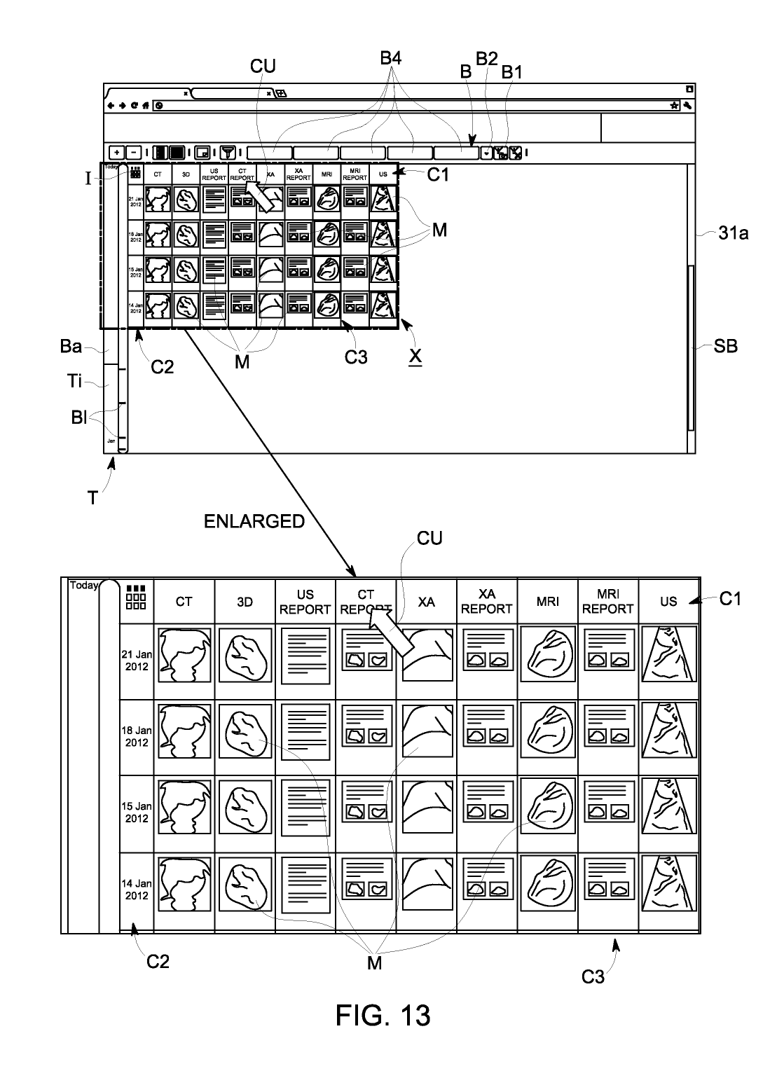

Next, at Step S8, the operator performs an operation similar to Step S4 at the view X displayed at Step S7 to select desired accompanying information again. Here, as shown in FIG. 13, “CT”, “3D” and “CT report” are selected using the cursor CU.

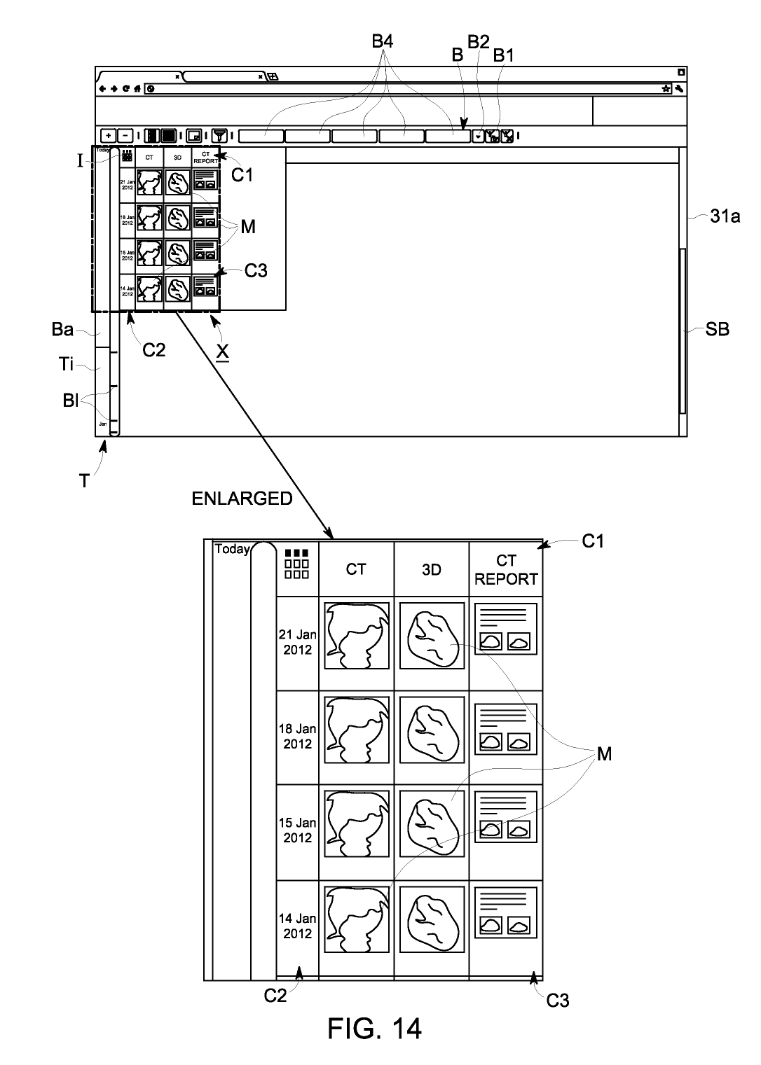

Next, at Step S9, the operator clicks the narrow-down display button B1 as with Step S5 to display, as shown in FIG. 14, a view X in which only simplified images M having the accompanying information selected at Step S8 have been displayed.

As explained above, as shown in FIG. 14, the simplified images M in which the practice setting corresponds to the “radiology department” and the “cardiovascular department”, and the document class corresponds to the CT image, 3D image and CT report, are displayed in the view X. The simplified images M displayed in the view X correspond to the simplified images having the accompanying information of the different attributes (practice setting and document class) selected at Steps S4 and 8 before and after the attribute alteration. At Step S10, the operator performs the operation of storing the accompanying information selected at Step S4 and 8 as narrow-down conditions for simplified images M, for causing a view X in which the same simplified images are displayed again later, to be displayed.

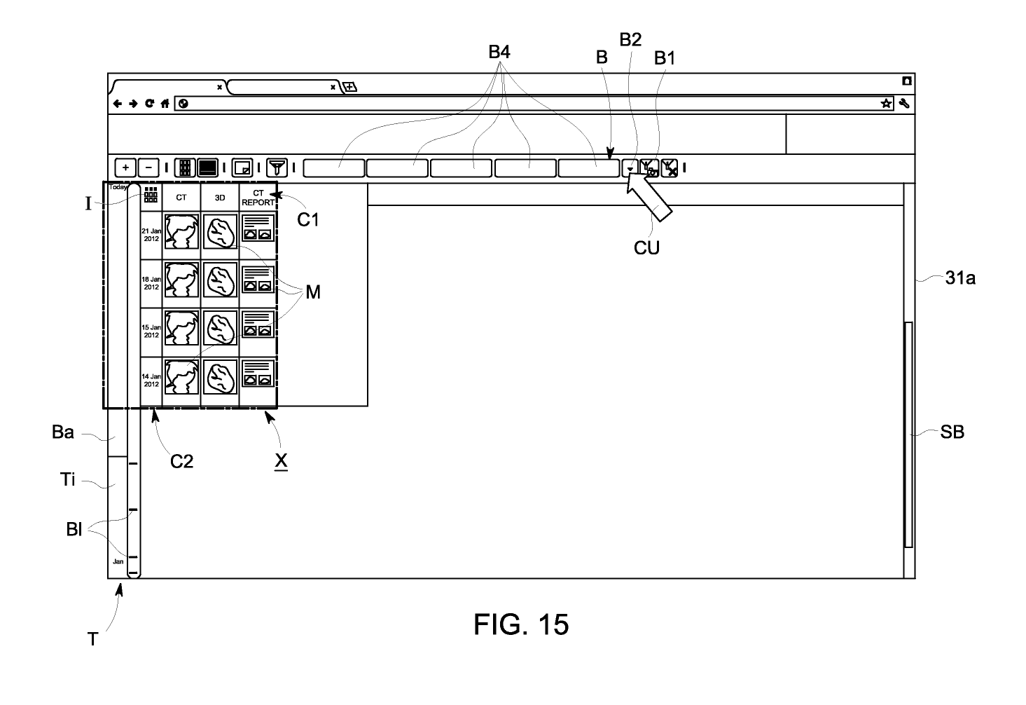

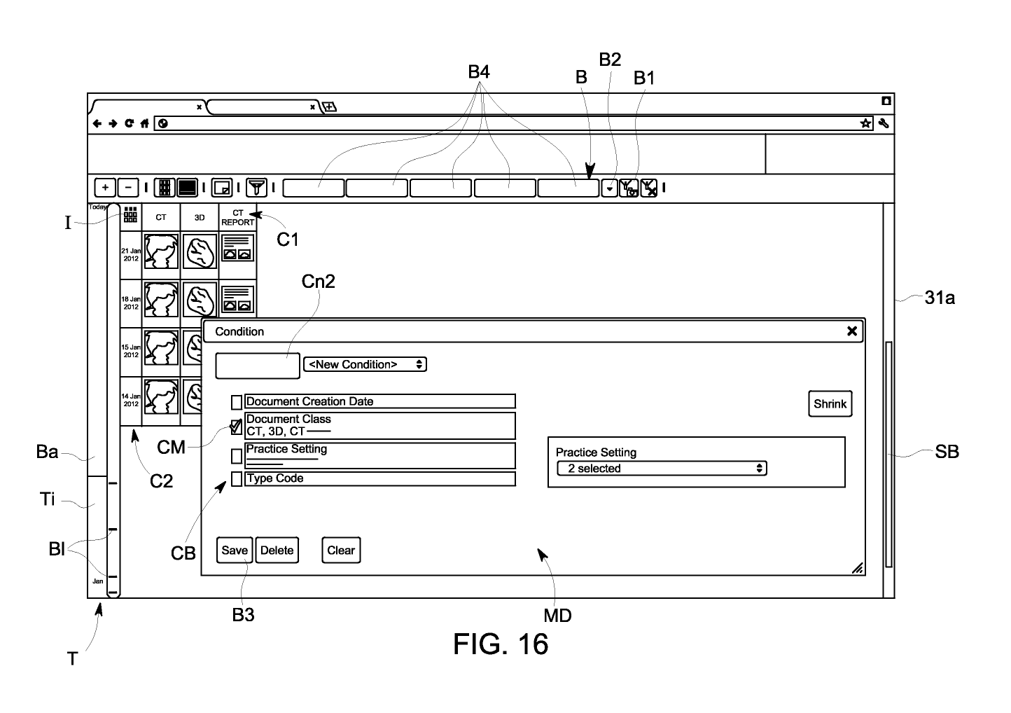

The operation at Step S10 will concretely be explained. First, the operator moves the cursor CU onto a metadata display button B2 using the input unit 33 as shown in FIG. 15. Then, when the metadata display button B2 is clicked, the display controller 32 causes a metadata display image MD to be displayed as shown in FIG. 16. The metadata display image MD is an image in which the accompanying information selected at each of Step S4 and S8 has been displayed, and is an image in which the accompanying information taken as the narrow-down conditions have been displayed. Specifically, the narrow-down conditions include the “radiology department”, “cardiovascular department”, “CT”, “3D” and “CT report”. It may become able to add or delete the narrow-down conditions.

Incidentally, in the metadata display image MD, a check mark CM (tick) has been displayed in a check box CB placed on the left side of the column of “Document Class”. The attributes in the view X displayed when the narrow-down conditions are registered, are attributes in which only simplified images M that the operator desires to finally display are displayed, i.e., attributes in which only simplified images M necessary for the operator are displayed. The display controller 32 causes the check mark CM to be displayed with respect to each of the attributes displayed upon registration of the narrow-down conditions in the metadata display image MD.

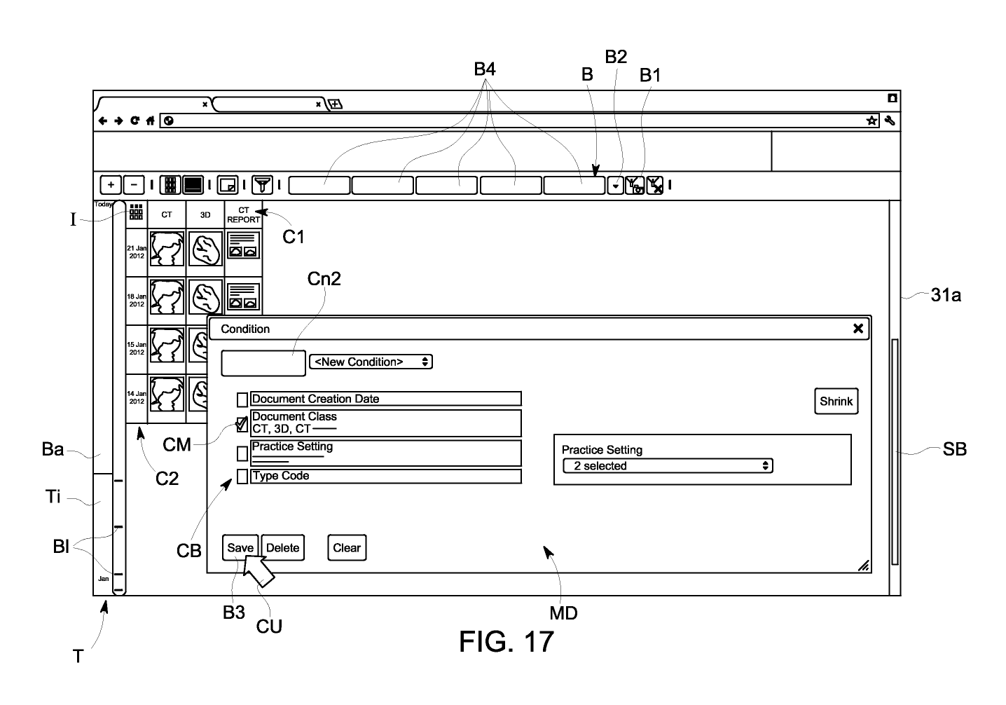

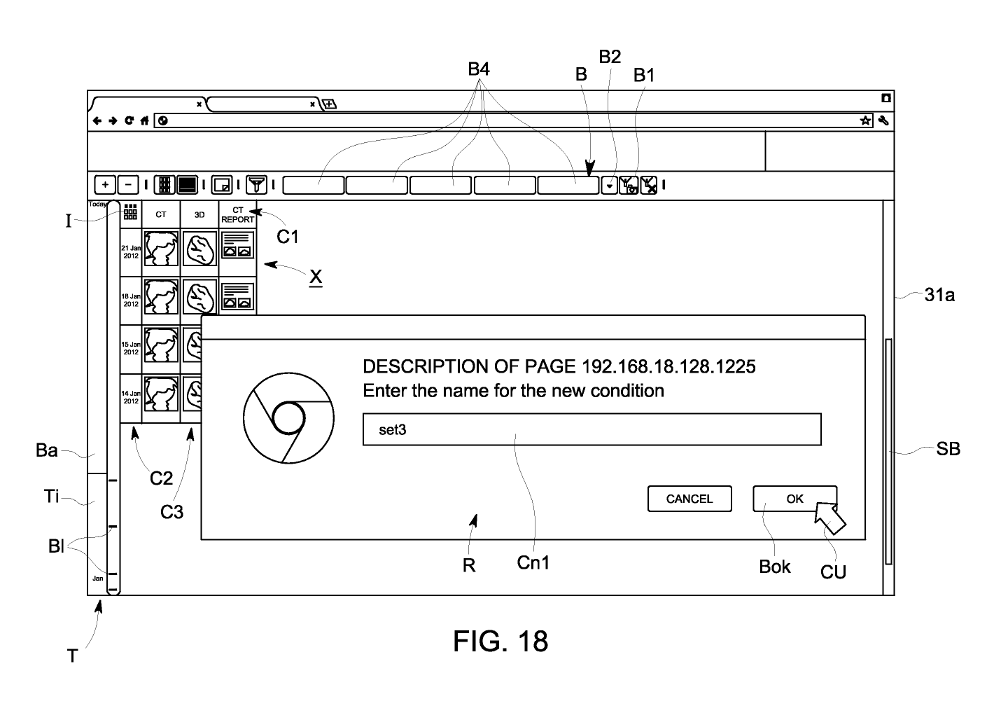

When the operator puts the cursor CU on a Save button B3 displayed in the metadata display image MD to click it as shown in FIG. 17, the display controller 32 causes a name registration image R for registering the name of a narrow-down condition to be displayed as shown in FIG. 18. When the operator inputs the name into a name input column Cnl of the name registration image R and presses an OK button Bok, the registration of the name is completed. Here, “set3” is registered as the name.

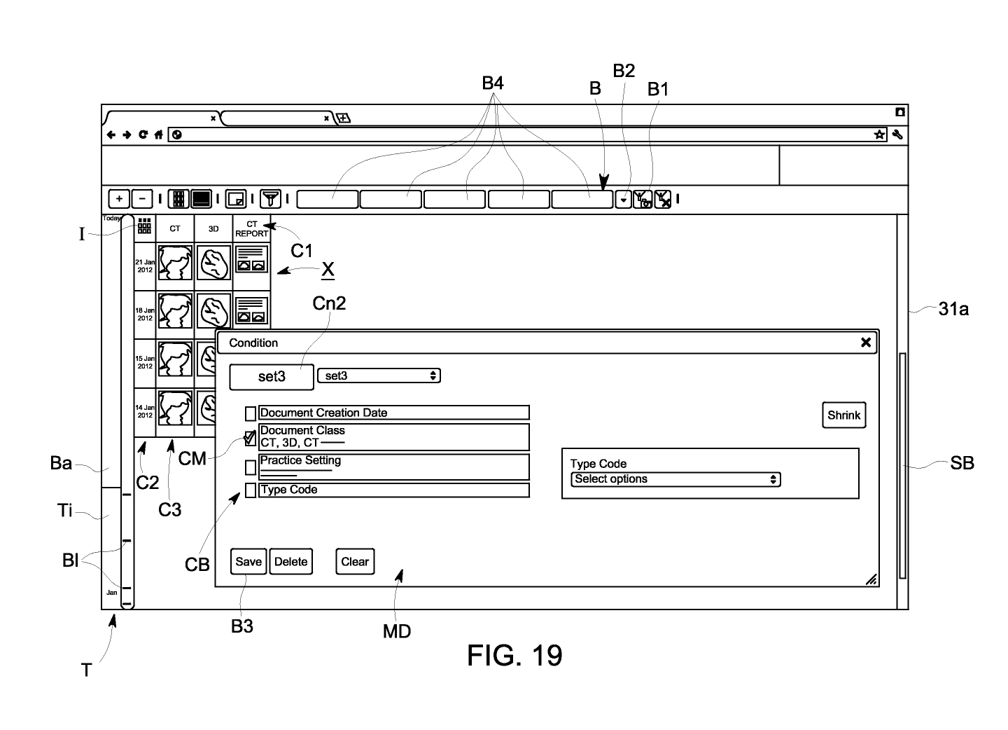

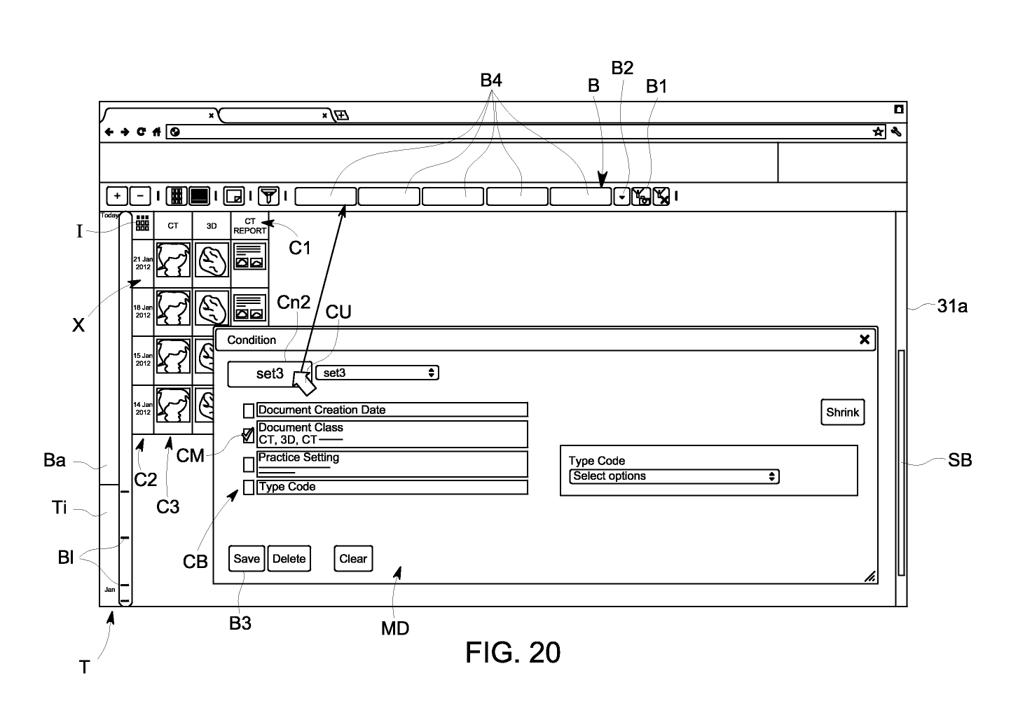

When the registration of the name is completed, the registered name is displayed in a name display section Cn2 of the metadata display image MD as shown in FIG. 19. Accompanying information displayed in the metadata display image MD is stored in the memory 35 and the storage unit 21 of the server 2 as narrow-down conditions. As shown in FIG. 20, when the cursor CU is dragged in matching with the name display section Cn2 and dropped to its corresponding search button B4, the name (“set3”) is displayed in the search button B4. With the search button B4 being pressed, the display controller 32 causes a view X of simplified images M having as accompanying information, narrow-down conditions (“radiology department”, “radiology department”, “CT”, “3D” and “CT report”) stored in the name of “set3” to be displayed.

Incidentally, there are provided a plurality of the search buttons B4 (five in the drawing), which enable a plurality of narrow-down conditions to be registered.

According to the present embodiment described above, the alteration of the attributes and the selection of the accompanying information are repeated on the display screen 31 a of the display unit 31, thereby making it possible to display the view X in which only the simplified images M necessary for the operator have been extracted from within many simplified images M, by the simple operation on the screen.

The narrow-down conditions for the simplified images M are stored and the search buttons B4 are displayed, thereby making it possible to simply display the view X having the simplified images M necessary for the operator only by pressing the search buttons B without changing the attribute of the display section C1 and selecting the accompanying information.

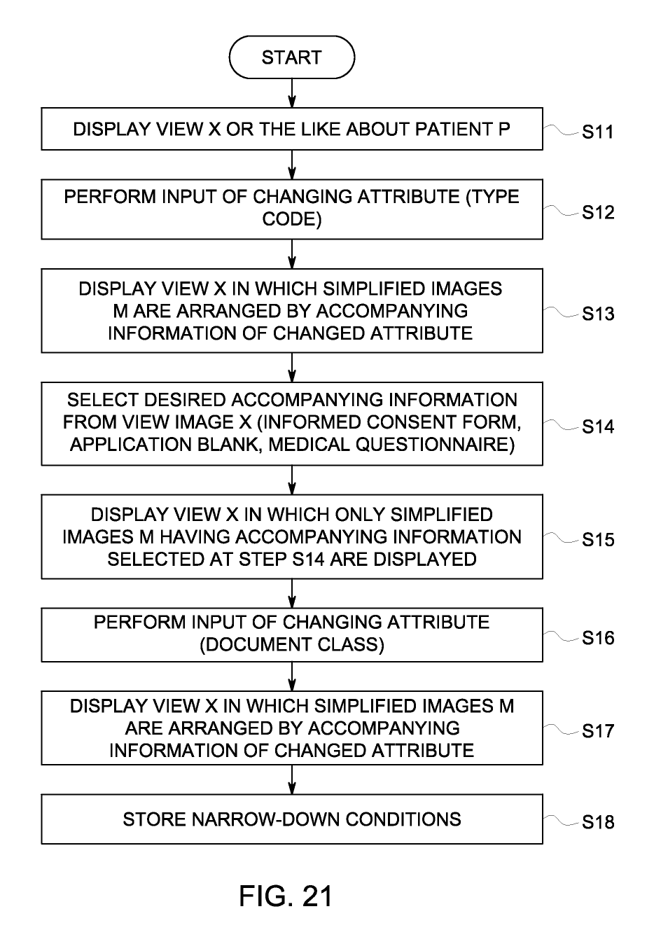

A second embodiment will next be described based on FIGS. 21 through 28. An image display system 1 of the second embodiment is identical in configuration to the first embodiment. The operation of the image display system 1 of the second embodiment will hereinafter be described based on a flowchart of FIG. 21.

In FIG. 21, at Step S11, a view X about each patient P, the period image T, the buttons B and the like are displayed as with Step 51 of FIG. 3. It is assumed that even at Step S11, as shown in FIG. 2, the document class is displayed in the display section C1 for the accompanying information, and the date is displayed in the display section C2 for the accompanying information.

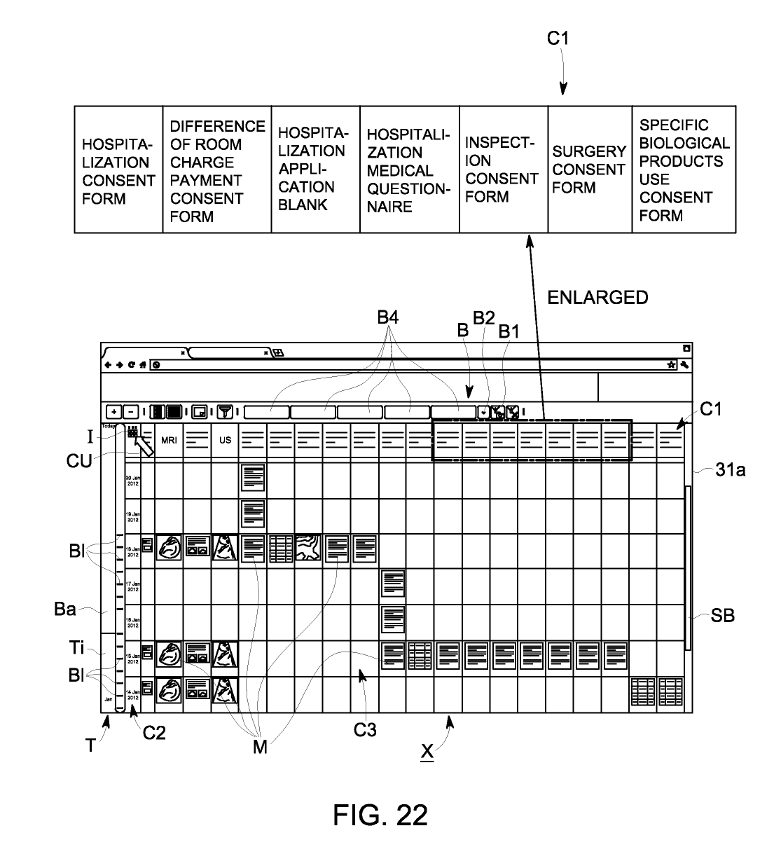

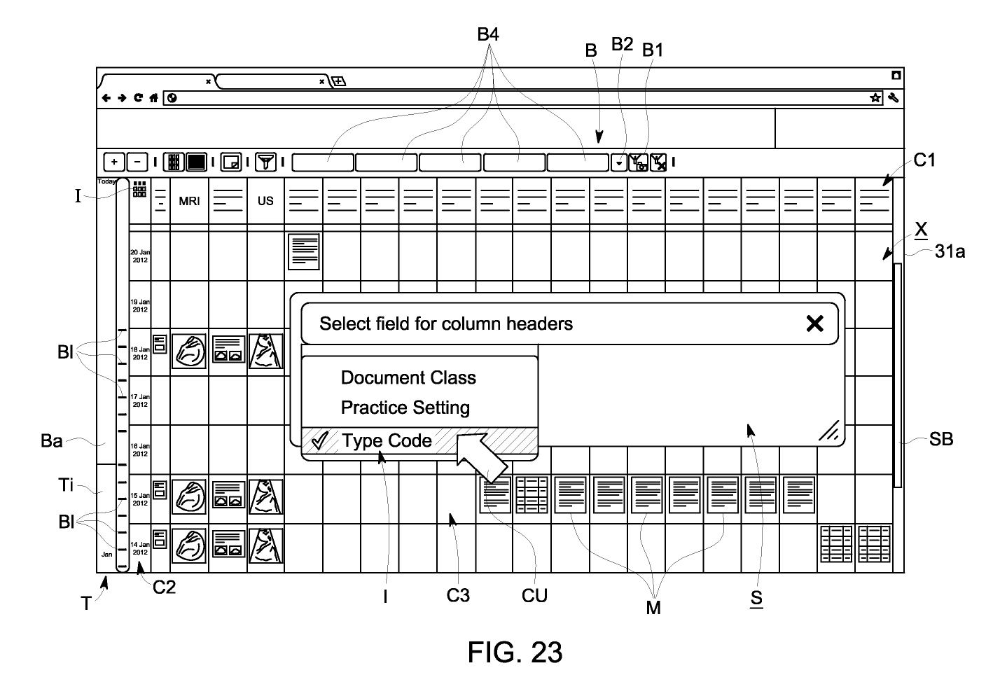

Next, at Step S12, an operator performs the input of changing the attribute of the display section C1 at the input unit 33. At Step S12, the attribute is changed to the type code. A concrete operation therefor is similar to Step S2. As shown in FIG. 22, the operator moves the cursor CU onto the attribute change icon I to click it, thereby displaying the attribute selection image S as shown in FIG. 23. Then, the operator places the cursor CU on “Type Code” at the attribute selection image S to click it.

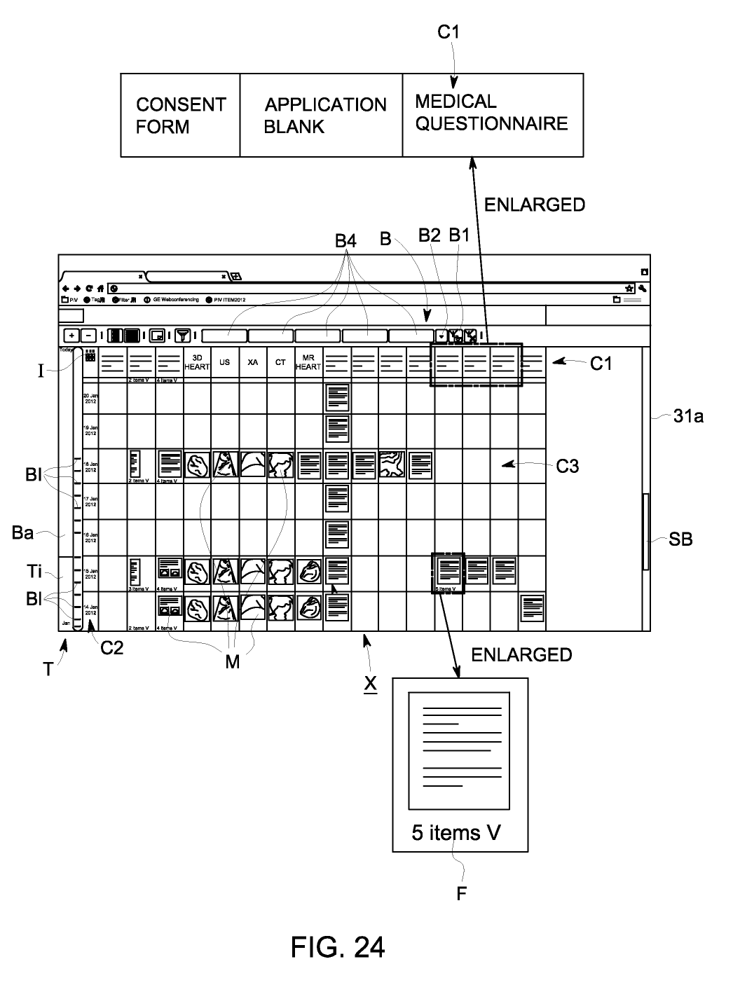

Here, as shown in partly enlarged form in FIG. 22, a plurality of consent forms such as a “hospitalization consent form”, a “difference of mom charge payment consent form”, an “inspection consent form”, a “surgery consent form”, a “specific biological products use consent form”, etc. are displayed in the display section C1. When the “Type Code” is clicked at Step S12, at Step S13, the display controller 32 causes a view X in which simples images M of respective type codes are arranged in the column direction, to be displayed as shown in FIG. 24.

Any of the above “hospitalization consent form”, “difference of room charge payment consent form”, “inspection consent form”, “surgery consent form”, and “specific biological products use consent form” is a “consent form” in the type code. Thus, the respective consent forms described above are combined into one as a consent form in the view X after the attributes have been changed. Characters of “5items” are displayed as the numerical representation F in the display section C3 of the simplified images corresponding to the “consent form” and “15 Jan 2012”. Thus, the operator is able to grasp that the five consent forms exist.

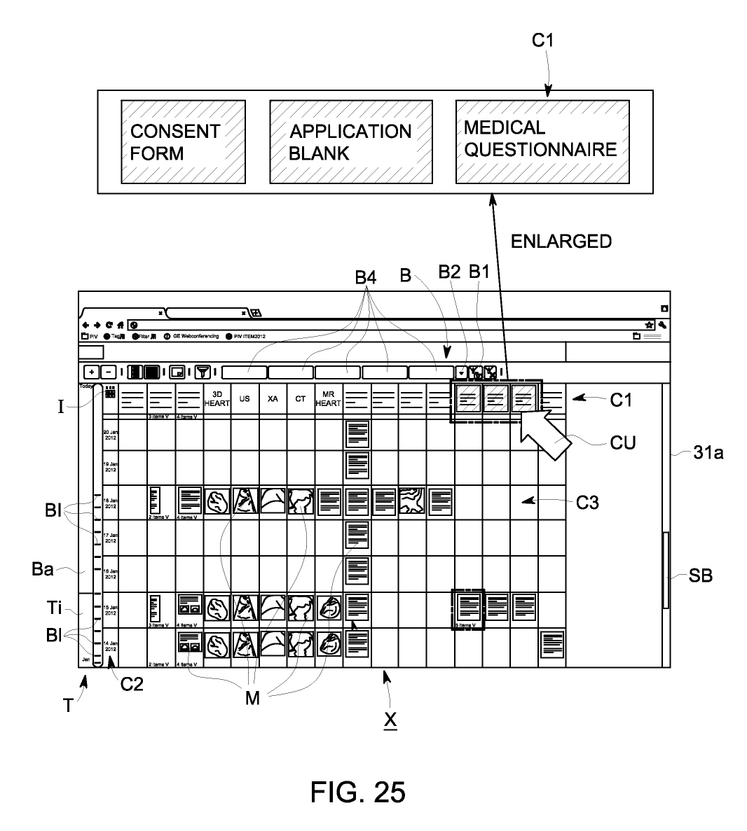

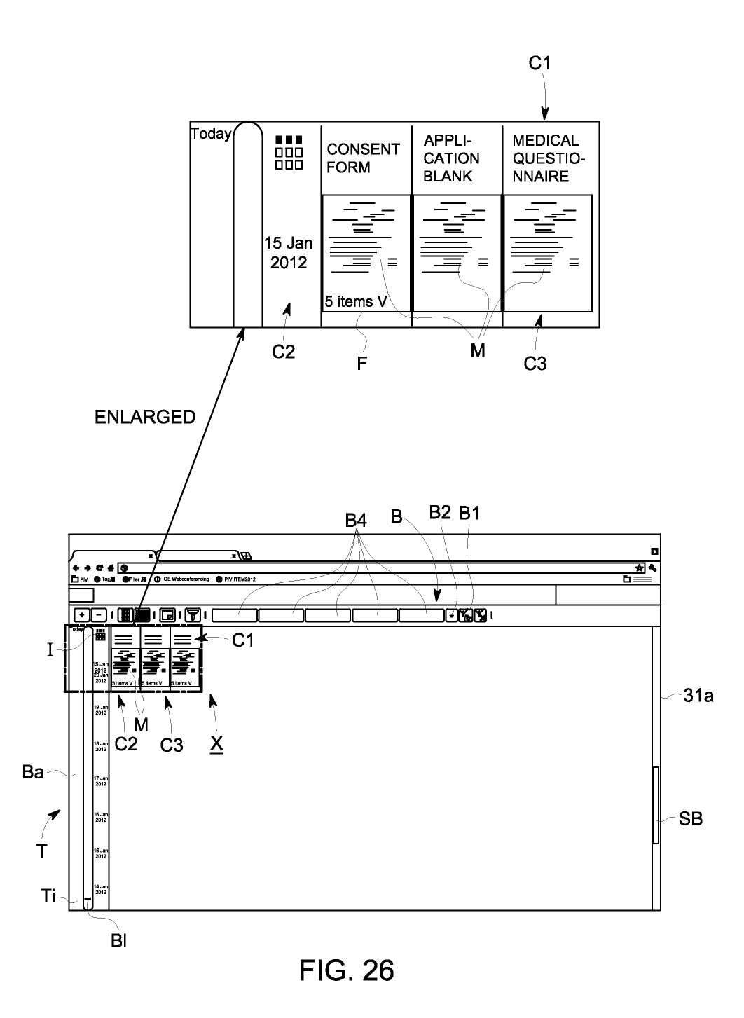

Next, at Step S14, the operator selects the “consent form”, “application blank” and “medical questionnaire” in the view X by the cursor CU as shown in FIG. 25. Next, at Step S15, the display controller 32 causes a view X in which only simplified images M of the “consent form”, “application blank” and “medical questionnaire” selected at Step S14 have been displayed, to be displayed as shown in FIG. 26. When the narrow-down display button B1 is clicked, the display controller 32 causes a view X in which only simplified images M of the “consent form”, “application blank” and “medical questionnaire” have been displayed, to be displayed as with Step S5 in FIG. 2.

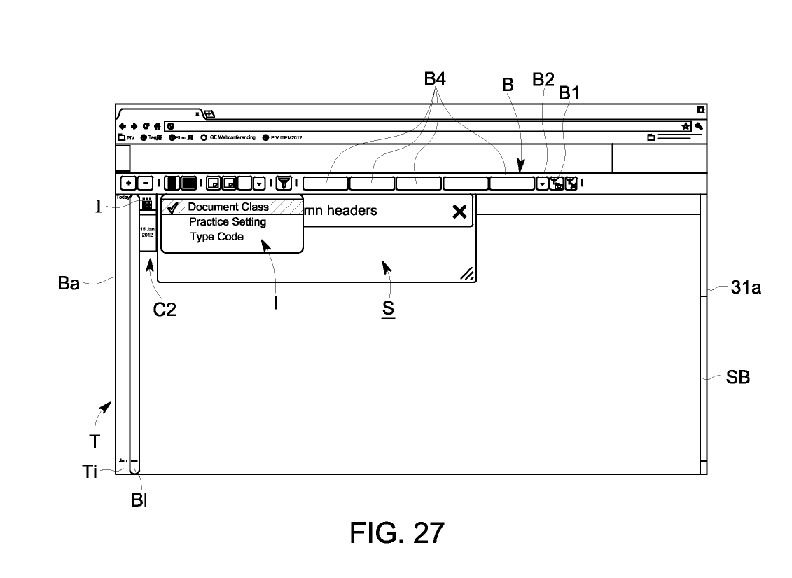

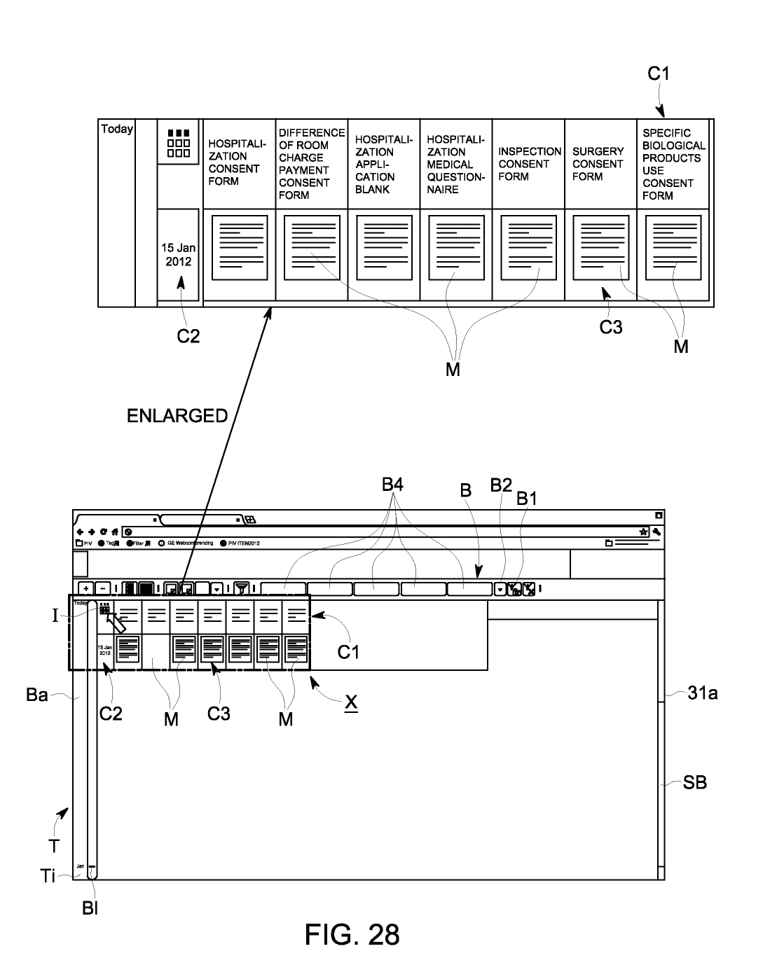

Next, at Step S16, the operator performs again the input of changing each attribute of the display section C1. Here, as shown in FIG. 27, “Document Class” is selected at the attribute selection image S. When the “Document Class” is selected at Step S16, at Step S17 as shown in FIG. 28, document classes are displayed in the display section C1 and yet a view X in which simplified images M of the respective document classes are arranged in the column direction is displayed in the display section C3. Simplified images M of a “hospitalization consent form”, a “difference of mom charge payment consent form”, a “hospitalization application blank”, a “hospitalization medical questionnaire”, an “inspection consent form”, a “surgery consent form”, a “specific biological products use consent form” are displayed in the view X.

Next, at Step S18, the operator performs the operation of storing the narrow-down conditions for the simplified images M as with above Step S10 in FIG. 2. In the present embodiment, the accompanying information displayed in the view X is stored as the narrow-down conditions. A concrete operation method is similar to Step S10. A description thereof will be omitted herein.

According to the present embodiment, in addition to having the same advantages as the first embodiment, the plural consent forms can be collectively displayed as shown in FIG. 24 even when the consent forms are separately displayed as shown in FIG. 22, and the operator misses them. It is thus possible to display all the consent forms without omission.

Although the present invention has been explained by the embodiments as described above, it is needless to say that the present invention can be changed in various ways within the scope that does not change the gist of the invention. For example, the attribute of the display section C2 for the accompanying information rather than the attribute of the display section C1 for the accompanying information may be changed.

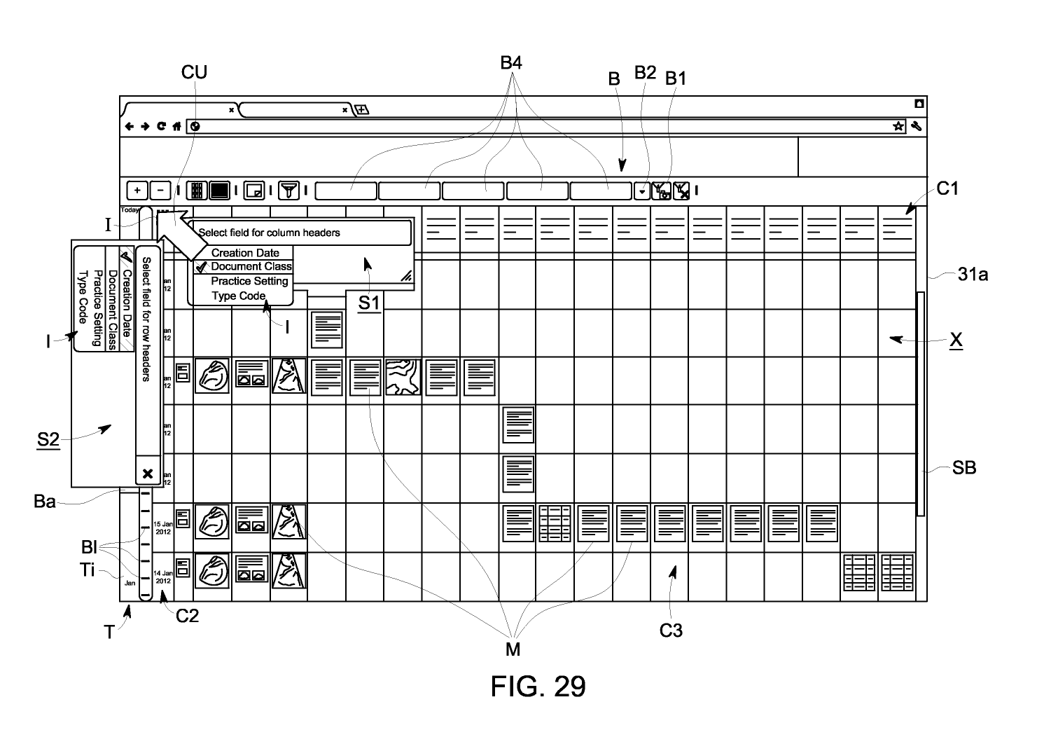

The respective attributes of the display section C1 and the display section C2 may be changed. In this case, as shown in FIG. 29, for example, when the attribute change icon I is clicked, the display controller 32 causes a first attribute selection image S1 and a second attribute selection image S2 to be displayed. The first attribute selection image S1 is an image for changing the attribute of the display section C1. The second attribute selection image S2 is an image for changing the attribute of the display section C2.

“Creating Date” is displayed in lists 1 of attributes at the first and second attribute selection images Si and S2 in addition to “Document Class”, “Practice Setting” and “Type Code”. This “Creation Date” means the date of generation of medical data. In FIG. 29, the attribute of the display section C1 corresponds to a document class, and the attribute of the display section C2 corresponds to a date. Accordingly, “Document Class” is highlighted in the list 1 of the first attribute selection image S1. “Creation Date” is highlighted in the list 1 of the second attribute selection image S2. When it is desired to change the attribute of the display section C2 to a type code, for example, the operator clicks “Type Code” in the list 1. When it is desired to change the attribute of the display section C2 to a practice setting, the operator clicks “Practice Setting” in the list 1. Thus, the attribute of the display section C1 is changed from the document class to the type code, and the attribute of the display section C2 is changed from the date to the practice setting.

When the respective attributes of the display sections C1 and C2 are supposed to be able to change in this manner, the accompanying information selected respectively from the display sections C1 and C2 or the accompanying information displayed in the view X can be stored as narrow-down conditions for simplified images M, for displaying again later, a view X in which the same simplified images M have been displayed.

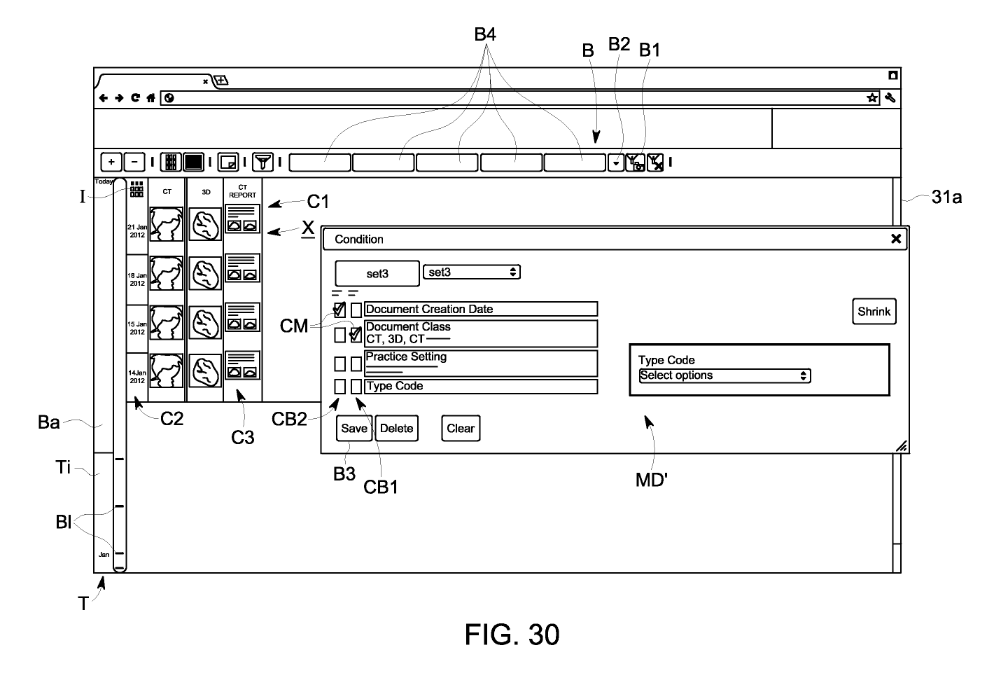

Specifically, when the metadata display button B2 is clicked, the display controller 32 causes a metadata display image MD' to be displayed as shown in FIG. 30. Check boxes CB1 (placed below “horizontal” characters in the drawing) for displaying check marks CM each indicative of the attribute displayed in the display section C1 for the accompanying information, and check boxes CB2 (placed below “vertical” characters in the drawing) for displaying check marks CM each indicative of the attribute displayed in the display section C2 for the accompanying information are displayed in the metadata display image MD'. Since the document class is displayed in the display section C1l in FIG. 30, the check mark CM is displayed in the lateral check box CB1 of “Document Class”, of the four check boxes CB1. Since the date is displayed in the display section C2 for the accompanying information, the check mark CM is displayed in the lateral check box CB2 of “Document Creation Date”, of the four check boxes CB2. In such a metadata display image MD', narrow-down conditions are stored by performing an operation similar to Step S10.

While the disclosed embodiments of the subject matter described herein have been shown in the drawings and fully described above with particularity and detail in connection with several exemplary embodiments, it will be apparent to those of ordinary skill in the art that many modifications, changes, and omissions are possible without materially departing from the novel teachings, the principles and concepts set forth herein, and advantages of the subject matter recited in the appended claims. Hence, the proper scope of the disclosed innovations should be determined only by the broadest interpretation of the appended claims so as to encompass all such modifications, changes, and omissions.

1. A display apparatus comprising:
a display controller for displaying a view of simplified images based on medical data having accompanying information of a plurality of attributes as metadata, wherein said view of simplified images being a matrix-like view in which the simplified images of the same patient are arranged by accompanying information of one attribute in a row direction and arranged by accompanying information of another attribute in a column direction; and
an input unit in which an operator performs input of changing the attribute in at least one of the row and column directions,
wherein the display controller rearranges the simplified images by accompanying information of the attribute that the operator changed using the input unit.

2. The display apparatus according to claim 1, wherein:
the input unit is capable of performing the input of selecting the accompanying information by the operator, and
the display controller causes the view to be displayed comprised of only simplified images having the accompanying information selected by the operator using the input unit.

3. The display apparatus according to claim 2, wherein the display controller causes the view to be displayed comprised of only simplified images having accompanying information of different attributes selected before and after the attribute change by the operator using the input unit.

4. The display apparatus according to claim 2, wherein the input of selecting the accompanying information at the input unit is the input of indicating desired accompanying information in the view.

5. A display apparatus comprising:
a display controller for displaying a view of simplified images based on medical data having accompanying information of a plurality of attributes as metadata, wherein said view of simplified images is a matrix-like view in which the simplified images of the same patient are arranged by accompanying information of one attribute in a row direction and arranged by accompanying information of another attribute in a column direction; and
an input unit which performs the input of changing the attribute in at least one of the column and row directions by selecting a desired attribute by an operator out of the plurality of attributes displayed in the display unit and the input of selecting desired accompanying information from the view displayed in the display unit;
wherein the display controller rearranges the simplified images by accompanying information of the attribute changed by the input unit and causes a view to be displayed comprised of only simplified images having the accompanying information selected by the input unit.

6. The display apparatus according to claim 1, wherein
the input unit is capable of performing the input of selecting accompanying information of the attribute changed using the input unit by the operator, and
the display controller causes the view to be displayed comprised of only simplified images having the accompanying information selected using the input unit by the operator.

7. The display apparatus according to claim 2, wherein:
the input unit is capable of performing the input of changing the attribute of the accompanying information selected using the input unit by the operator, and
when the input of changing the attribute of the accompanying information selected using the input unit by the operator is performed, the display controller rearranges the simplified images by accompanying information of the post-change attribute.

8. The display apparatus according to claim 1, wherein, in order to perform the input of changing the attribute at the input unit, the display controller causes the display unit to display an attribute selection image in which the operator is able to perform the input of selecting a desired attribute.

9. The display apparatus according to claim 8, wherein the attribute displayed in the attribute selection image is editable.

10. The display apparatus according to any one of claims 1, wherein in the view, thumbnail images are displayed as the simplified images.

11. The display apparatus according to claim 2, further including a storage unit for storing the accompanying information selected at the input unit or the accompanying information of the attribute changed by the input unit, as narrow-down conditions for the simplified images displayed in the view.

12. The display apparatus according to claim 1, wherein:
the view includes a display section for the accompanying information and a display section for the simplified images, and
when input of changing the attribute at the input unit is performed, the display controller displays accompanying information of the changed attribute in the display section for the accompanying information and rearranges the simplified images in the display section for the simplified images.

13. The display apparatus according to claim 12, wherein the display section for the accompanying information displays accompanying information of the same attribute in a column direction and displays accompanying information of the same attribute in a row direction.

14. The display apparatus according to claim 1, wherein, when simplified image specified from the two accompanying information corresponding to the accompanying information of the one attribute and the accompanying information of the another attributes exists more than one, the display controller causes any one of the plurality of simplified images and numeral indicative of the number of the simplified images to be displayed.

15. The display apparatus according to claim 1, wherein the medical data include document data and medical image data acquired by a modality.

16. An image display system having a server and a display apparatus,
wherein said display apparatus comprises:
a display controller for displaying a view of simplified images based on medical data having accompanying information of a plurality of attributes as metadata, wherein said view of simplified images being a matrix-like view in which the simplified images of the same patient are arranged by accompanying information of one attribute in a row direction and arranged by accompanying information of another attribute in a column direction; and
an input unit in which an operator performs input of changing the attribute in at least one of the row and column directions,
wherein the display controller rearranges the simplified images by accompanying information of the attribute that the operator changed using the input unit; and
wherein said server comprises a storage unit which stores the medical data therein.

17. The image display system according to claim 16, wherein the storage unit of the server stores the accompanying information selected by an operator at the input unit of the display apparatus or the accompanying information of the attribute changed by the input unit, as narrow-down conditions for the simplified images displayed in the view.

18. The display apparatus according to claim 5, wherein:
the input unit is capable of performing the input of selecting accompanying information of the attribute changed using the input unit by the operator, and
the display controller causes the view to be displayed comprised of only simplified images having the accompanying information selected using the input unit by the operator.

19. The display apparatus according to claim 5, wherein:
the input unit is capable of performing the input of changing the attribute of the accompanying information selected using the input unit by the operator, and
when the input of changing the attribute of the accompanying information selected using the input unit by the operator is performed, the display controller rearranges the simplified images by accompanying information of the post-change attribute.

20. The display apparatus according to claim 5, wherein, in order to perform the input of changing the attribute at the input unit, the display controller causes the display unit to display an attribute selection image in which the operator is able to perform the input of selecting a desired attribute.
